(19) United States
(12) Patent Application Publication
(10) Pub. No.: US 2014/0108215 A1
(43) Pub. Date: Apr. 17, 2014

(54) SYSTEM AND METHODS FOR TRADING

(71) Applicant: OPTIONSXPRESS HOLDINGS, INC., Chicago, IL (US)

(72) Inventors: Quinn Kirsch, Chicago, IL (US); Amad Amin, Streamwood, IL (US)

(73) Assignee: OPTIONSXPRESS HOLDINGS, INC., Chicago, IL (US)

(21) Appl. No.: 13/650,959

(22) Filed: Oct. 12, 2012

(51) Int. Cl. G06Q 40/04

(52) U.S. Cl. 705/37

(57) ABSTRACT

A system and methods for trading configured to permit an investor to transfer a request to a trading institution, the request including instructions to send a series of orders to a forum in which each subsequent order includes a parameter that changes relative to the other orders, generally moving from a start point towards an end point. The one or more changing parameters—termed dynamic parameters—are reconfigured automatically upon the occurrence of a reconfiguration event.

### FIELD OF THE INVENTION

The present invention relates generally to a system and methods for trading items. One preferred embodiment of the system and methods permits customers to transfer one request to a financial institution that causes a series of trade orders—each having at least one dynamic parameter—to be sent to a trading forum.

### BACKGROUND OF THE INVENTION

Financial institutions, including brokerages, have developed and implemented certain online services that allow investors to engage in trading of various securities over data communication networks, including the Internet. Various known systems and methods for trading permit an investor to provide a broker or brokerage with instructions for executing the trade via the data communication network.

For purposes of this application, the term “trading” includes the transfer of any consideration in exchange for that which is the subject of the trade. The subject of the trade is termed an “item” in this application. An item may be anything of value including a “financial security”. For purposes of this application, a “financial security” or “security” includes stocks, commodities, bonds, and derivatives such as futures, forwards, options, futures options, equities, and swaps. A “customer” is any individual or entity that may or does engage in the trading of items whose value varies according to market perception such as coins, stamps, books, objects of fine art, craftsmanship, and those having historical significance, among others. A customer is also referred to as an “investor” for purposes of this application. The present invention has application to all such items, including properties and securities that may be bought and sold in a generally open marketplace at a price that varies according to market perception, including with respect to the trading of stock equity options. Embodiments of the present invention will be described by reference to one type of item—financial security—but may be used with respect to all items.

Financial institutions have developed certain standardized sets of instructions for trading that may be easily transferred to and understood by a financial institution. Using that standardized set, an investor can prepare an instruction set and transfer it to a financial institution, for example, by telephone, by facsimile, by electronic mail, by a communication element of a system, by a data communication network, or by another means. The financial institution may evaluate the instructions for certain characteristics and may store the instructions for an appropriate period of time. If necessary, the financial institution develops an “order”—that is, a set of instructions formatted and configured to be sent to a trading forum—from the instructions. For purposes of this application, a “trading forum” or “forum” may include a financial security exchange, a group of exchanges, a market maker, auction house, liquidity pool, a department of the financial institution that provides the trading system, or any other entity that may execute a trade.

The financial institution typically sends the order to the trading forum, where it may be executed. If the trade described in the order is not executed, the order may expire upon the passage of a certain predetermined or investor-selected period of time such as a fraction of a second, one second, two seconds, one minute, ten minutes, one hour, or one day after the order is sent or after the order is received by the forum. The order also may expire upon reaching a certain predetermined or investor-selected time, such as close of business, 12:00 p.m. Central Time, or 4:00 p.m. Eastern Time. Also, the investor may request that the financial institution cancel the order from the trading forum before the order expires. For purposes of this application, an order is “active” from when it is received by the trading forum until either the trade is executed, or the order is expired or cancelled, and accordingly, removed from the trading forum.

Conventional instructions sets provided by financial institutions may permit the investor to designate various parameters of a trade. For purposes of this application, a “parameter” of a trade includes the required elements for executing the trade, which may include whether to buy or sell; which type of security to trade (e.g., stocks, commodities, bonds, or derivatives); which security instrument to trade (e.g., Dell, Apple, Monsanto, any technology company, any U.S. company, any Non-U.S. company, etc.), quantity of securities to be traded; whether the entire quantity of securities must be traded in one transaction; if less than the entire quantity of securities may be traded, then how many transactions are permitted to execute the entire order; at what specific price the trade may be executed; in what price range the trade may be executed; whether the trade is associated with other trades as part of a trading strategy, and number of legs that may be included in a trading strategy. Additional parameters may include in which trading forum the security may be traded, whether any part or all of the order may be displayed on a public trading forum, how long the financial institution should store the order before sending it to a trading forum, and when the financial institution should cancel the order and remove it from the trading forum. Also, parameters may include information about an underlying asset, such as in options that include a contract that grants the holder the right, but not the obligation, to buy or sell a particular underlying asset under certain terms. Varying sets of parameters may be relevant to various trading scenarios.

One conventional set of trading instructions termed a “market instruction set” permits the investor to designate a type of financial security to trade (e.g., stock), the specific instrument to trade (e.g., shares of Dell stock), whether to buy or sell, and the quantity of instruments to trade (e.g., 1, 15, 100). It is implicit that the financial institution will send a market order resulting from the market instruction set to the forum as fast as possible after receiving the instructions and the trade will be executed at the market price available at the time the market order reaches the forum. There are certain disadvantages associated with using market instruction sets. For example, the market price can change quickly, and accordingly, the price at execution of the trade may be different than the market price at the time the investor transferred the request to the financial institution.

Another conventional set of instructions termed a “limit instruction set” that may be changed into a “limit order”. A limit instruction set permits an investor to designate a type of financial security to trade, the specific instrument to trade, the quantity of instruments to trade, whether to buy or sell, and the limit price—that is, the highest price or lowest price at which the trade should be executed (e.g., buy when the selling price is below $12 per unit or sell when the buying price is above $20 per unit). It is implicit that the forum will permit execution of the trade only if and when the security is available for trade within the values designated as the limit price. There are certain disadvantages associated with using limit instruction sets. For example, if the financial security does not become available within the values designated as limit price, a trade will never occur.

Certain conventional set of instructions include a condition such that the financial institution is instructed to send the resulting order to the forum for execution as soon as possible after the occurrence of a condition. There are certain disadvantages associated with such known conditional orders. For example, in certain known systems and methods, a price condition may be used to control the time at which the order is sent to the forum. Accordingly, if an investor wishes orders be sent at multiple times having multiple price conditions, the investor must submit multiple requests.

Another conventional system for trading is configured to permit a market participant to automatically trade a relatively large quantity order as multiple, relatively smaller, component orders, that are often sent in a random sequence having random price limits. A market participant generally will not submit a single buy/sell order because exposing an order with a large quantity often causes adverse price effects to the disadvantage of the market participant. There are certain shortcomings with such a system. For example, multiple transactions are required to obtain the entire quantity of items desired, which may increase transaction cost and decrease the likelihood that all transactions occur. Also, because the system sends orders that have random price limits in a random sequence, it does not permit an investor to prioritize the time and price at which it wishes to make a trade.

Accordingly, there is a demand for an efficient system and methods by which an investor may transfer a single request to a financial institution, the receipt of which causes it to send a series of orders to a forum in a particular order—each order distinguishable in that at least one parameter changes relative to the parameter in the earlier order—and each order in the series is cancelled if not filled at the occurrence of an event, which maximizes the opportunities to execute a trade at the most desirable parameters at the soonest time. The present invention satisfies this demand.

### SUMMARY OF THE INVENTION

Embodiments of the present invention permit an investor to prepare and transfer a request—that is, a set of instructions for preparing orders having specified trading parameters—to a financial institution and the financial institution to promptly implement the request, for example, by sending one or a series of orders to the forum. The investor, or a broker on the investor's behalf, prepares and transfers the request. After the request is transferred, additional user intervention is not necessary in certain embodiments.

As identified above, the term “parameter” or “trading parameter” refers to the elements required for executing the trade. In certain embodiments, each and every parameter must be met or fulfilled by market conditions in order for the trade to be executed. However, in other embodiments, certain parameters may be made optional such that a trade in which that optional parameter is fulfilled is attempted, but if not available, a trade that does not include the optional parameter value will still be executed.

Embodiments of a request permit the selection or reviewing of the parameters for a trade. A request may include a set of parameters termed “initial parameters”, which are those parameters necessary for the preparation of the first order to be sent to the forum, and “reconfiguration parameters”, which are those parameters necessary for the preparation of reconfigured orders. A simple embodiment of initial parameters may include whether to buy or sell, which security instrument, and any other parameters relevant to the trade execution may be predetermined by the financial institution. Other embodiments of initial parameters include quantity of security traded, price/price range at which the trade may be executed in response to the first order, or any other parameter.

If the market conditions reach the conditions called for by the initial parameters, a trade will be executed and the first order is fulfilled. If market conditions are such that the initial parameters have not been met and the order is still pending at the occurrence of a reconfiguration event, the pending order will be cancelled and a new, reconfigured order will be prepared and sent to the forum. In other words, each time a reconfiguration event occurs, the system determines whether the order has been executed, and if not, a reconfiguration of parameters may occur automatically—that is, without any additional intervention from the investor—according to certain reconfiguration parameters defined in the request. A series of reconfiguration events may result in a series of successive reconfigured orders sent to a forum, such as an initial parameters order followed by a first iteration reconfigured order, followed by a second iteration reconfigured order, and so on. In certain embodiments, only one order resulting from the request is active at any given time, and accordingly, two orders resulting from the same request are never co-pending.

In each successive order, at least one parameter—termed a “dynamic parameter”—differs relative to its respective parameter in the previous order. In the first order, the dynamic parameter is at its “start point”, and in each successive order, the dynamic parameter moves towards an “end point”—that is, the value of the dynamic parameter at which, if the order has not been executed yet, the order then either will remain on the forum until expiration or will be cancelled, and no subsequent orders will be sent automatically.

In certain embodiments of the present invention, the dynamic parameter may be the limit price at which the investor is willing to execute the trade, limit price range within which the investor is willing to execute the trade, quantity of securities to be traded, the quantity of the securities displayed in the forum, or any other trading parameters. Certain embodiments may permit the investor to designate multiple dynamic parameters. In such embodiments, the multiple dynamic parameters may have a direct relationship in which both dynamic parameters increase or decrease in each iteration or an inverse relationship in which a first dynamic parameter increases as a second dynamic parameter decreases. An example of multiple dynamic parameters having an inverse relationship may include a decrease in the quantity of securities requested as the price at which the investor is willing to purchase a security increases in each iteration.

In certain embodiments, a reconfiguration event may include the passage of time, number of securities available to be traded in the forum, bid price—that is, the price of the highest priced buy order that is currently available—of a security, ask price—that is, the price of the highest priced sell order that is currently available—of a security, market price fluctuations, news event such as press release or press coverage related to the security or an industry with which the security is associated, or another parameter.

Certain embodiments permit the investor to designate the reconfiguration event or details about the reconfiguration event, for example, from a number of choices. If the reconfiguration event is time, the reconfiguration event may be the passage of a certain number of milliseconds, seconds, minutes, hours, days, weeks, or months, or may include reaching a specified time such as 12:00 p.m. Central Time or 4:00 p.m. Eastern Time. If the reconfiguration event is a bid price or ask price available in the forum, the system may request information regarding such price from an information source at certain pre-determined or investor designated intervals (e.g., every millisecond, every second, every 10 seconds, every 30 seconds, every 5 minutes, etc.). In other embodiments, the reconfiguration event is selected implicitly by the selection of a certain type of request or is predetermined by a financial institution.

In each reconfigured order, the dynamic parameter may differ by a certain amount, termed an “increment” for purposes of this application. The increment may be static such that the dynamic parameter differs by the same amount in each successive order (e.g., dynamic parameter such as limit price goes up/down by 1 cent in each iteration; in other words, if the increment is $0.05 and start point=$20 price, then 1st iteration=$20.05; 2nd iteration=$20.10; 3rd iteration=$20.15). In other embodiments, the increment may evolve according to a pattern (e.g., dynamic parameter such as limit price goes up/down by number in, for example, an arithmetic sequence, geometric sequence, triangular numbers, square numbers, cube numbers, or Fibonacci numbers in each iteration). Also, the increment may be randomly selected within a boundary (e.g., instruct the system to generate random incremental changes between 1 and 10 units every iteration). In addition, the increment may be multi-directional such that a dynamic parameter moves in one direction for one or more iterations, and then moves in a second direction for one or more iterations (e.g., dynamic parameter goes up 2 units, up 2 units, down 1 unit, down 3 units, up 1 unit, etc.). The increment may also be unidirectional such that the value goes upward in every iteration, or, in other embodiments, the increment may be unidirectional such that the value goes downward in every iteration.

The increment value also may be expressed as the number of orders that the financial institution should send to the forum (e.g., 3, 4, 5, 6, 7, 8, 9, 10, 11, 12 in, for example, evenly spaced time intervals between the start point and the end point).

The direction of the increment value may be implied, predetermined, or selected by the investor. When selected by the investor, the “+” sign may be used to indicate moving in an upward direction and the “−” sign may be used to indicate moving in a downward direction. Other known symbols may be used as well.

The increment value also may be an ordered list of non-numeric values such as a list of securities (e.g., 1. Dell, 2. IBM, 3. Apple, etc.) for purposes of a non-numeric dynamic parameter.

The group of parameters described above that are typically designated in the request and provide instructions regarding preparing reconfigured orders are termed “reconfiguration parameters” for purposes of this application. Specifically, reconfiguration parameters include at least one of a dynamic parameter, start point, end point, an increment, or reconfiguration event.

The set of parameters in each reconfigured order is termed “iterative reconfigured parameters” for purposes of this application. Specifically, for purposes of discussion, an embodiment may include initial parameters that indicate: buy 100 shares of Dell stock, and the reconfiguration parameters indicate a dynamic parameter that is the limit price, starting point is $20.00, ending point is $20.03, and the increment is one cent. In such an embodiment, the iterative reconfigured parameters for the first iteration reconfigured order would be buy 100 shares of Dell stock at $20.01 and below. The iterative reconfigured parameters for the second iteration reconfigured order would be buy 100 shares of Dell stock at $20.02 and below. The iterative reconfigured parameters for the third iteration reconfigured order would be buy 100 shares of Dell stock at $20.03 and below.

A financial institution may provide a system by which a trading screen can be viewed by a customer. A trading screen is configured to permit a customer to designate certain parameters, such as initial order parameters and reconfiguration parameters, for a trade to form an order. The trading screen may offer an option to finalize and transfer the order to the financial institution. The system and methods permit the financial institution to receive and review such as to validate the order to ensure that the request includes all of the relevant information. The system and methods permit the financial institution to prepare and send the initial parameters order, possibly as a market order, limit order, or other type of order. Certain embodiments of the system can detect whether the reconfiguration event has occurred on a periodic basis. In embodiments in which the reconfiguration event is time, the order remains active in the forum and available for execution for the selected time interval. At the end of the time interval, an inquiry is conducted to ascertain whether the order has been fully filled. If the order has been fully filled, a confirmation of the trade execution is transmitted to the investor, and the process ends. If, after the first inquiry, the order is not fully filled, an evaluation regarding whether the dynamic parameter has reached the end point is performed. If the dynamic parameter has reached the end point, the order remains on the forum until it expires or is cancelled. If the dynamic parameter has not reached the end point, the order is cancelled automatically and the financial institution receives a confirmation of the cancelled status of that iteration of the order. In certain embodiments, a second inquiry may be conducted to review the status of the previous iteration of the order. Upon finding that the order has been cancelled, a reconfigured order is prepared by taking the dynamic parameter value of the previous iteration and increasing or decreasing the value by the value of the increment (or moving to a subsequent item on an increment list in the case of non-numeric dynamic parameters). The reconfiguration also may include changing the quantity parameter in the order, especially if any part of the order was filled in the previous iteration. However, some orders are designated “all or nothing” orders, and the quantity never changes among the reconfigured orders resulting from a single request. After reconfiguration, the reconfigured order is sent to the forum and certain method steps are repeated until the pending order is completely filled, the dynamic parameter reaches the end point, or the order expires or is cancelled.

When an order is sent to a forum, it may be always sent to a single forum or one of multiple forums. The multiple forums may be selected using investor-identified selection criteria or financial institution generated selection criteria, or random selection. In each selection process, the criteria may include best prices available, bandwidth for electronic transfer, rate of execution, transaction costs, or other criteria. Certain sets of the selection criteria may be termed “smart routing” of trading orders, in which certain algorithms are used to select the forum.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1A illustrates a method embodiment of the present invention;

FIG. 1B illustrates a method embodiment of the present invention;

FIG. 2 illustrates a method embodiment of the present invention;

FIG. 3 illustrates a method embodiment of the present invention;

FIG. 4 illustrates a method embodiment of the present invention;

FIG. 5 illustrates a method embodiment of the present invention;

FIG. 6 illustrates a system embodiment of the present invention including a client computer system and a server;

FIG. 7 illustrates an exemplary client computer system;

FIG. 8 illustrates an exemplary cloud computing system;

FIG. 9A illustrates an embodiment of a web page according to the present invention;

FIG. 9B illustrates an embodiment of a web page according to the present invention;

FIG. 9C illustrates an embodiment of a web page according to the present invention;

FIG. 10A illustrates an embodiment of a web page according to the present invention;

FIG. 10B illustrates an embodiment of a web page according to the present invention;

FIG. 10C illustrates an embodiment of a web page according to the present invention;

FIG. 11 illustrates an embodiment of a web page according to the present invention;

FIG. 12A illustrates an embodiment of a web page according to the present invention;

FIG. 12B illustrates an embodiment of a web page according to the present invention;

FIG. 12C illustrates an embodiment of a web page according to the present invention;

FIG. 13 illustrates an embodiment of a web page according to the present invention;

FIG. 14 illustrates an embodiment of a web page according to the present invention;

FIG. 15 illustrates an embodiment of a web page according to the present invention;

FIG. 16A through FIG. 16D illustrate the progression of an order status display; and

FIG. 17 illustrates an embodiment of a web page according to the present invention.

### DETAILED DESCRIPTION OF EMBODIMENTS OF THE INVENTION

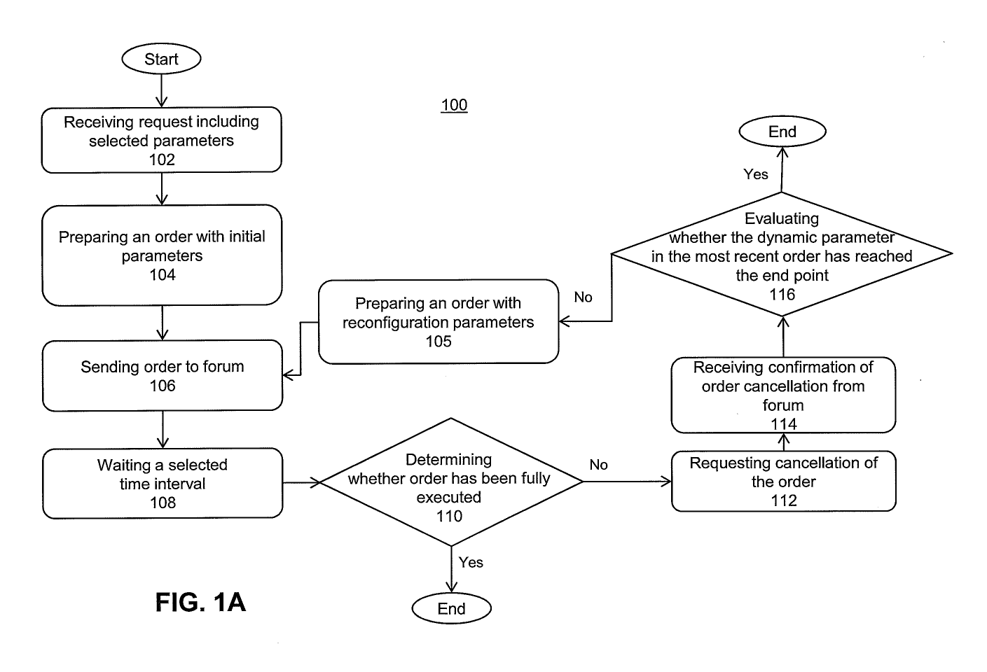

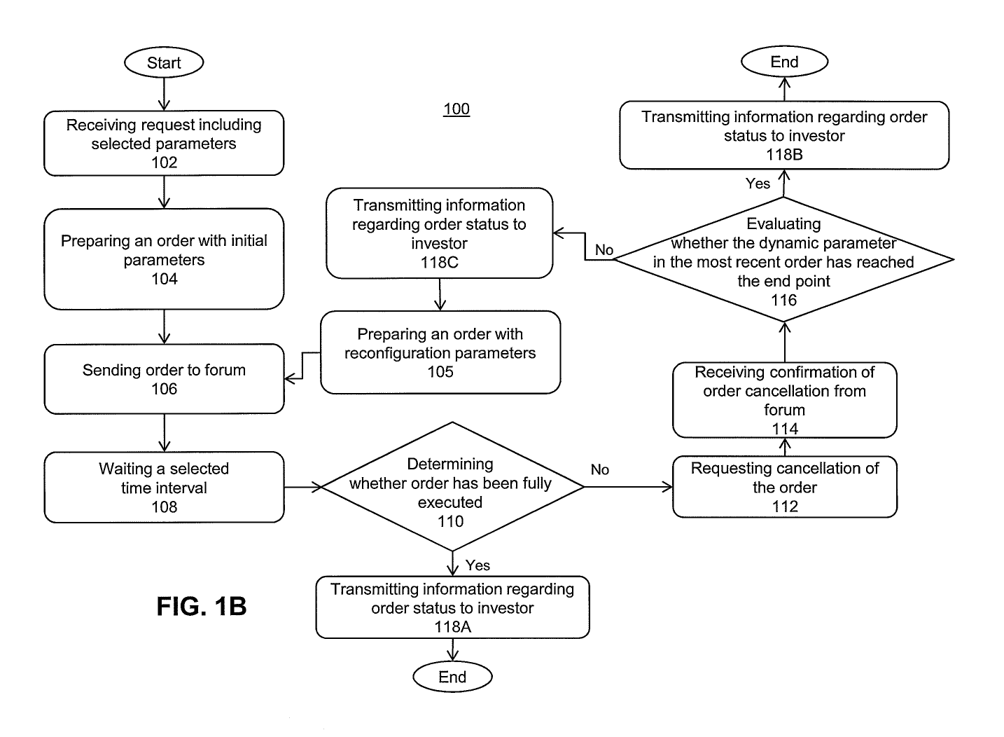

FIG. 1A illustrates one embodiment of a computer-implemented system and method 100 according to the present invention. The system and method 100 (termed a “trading system”) permits a financial institution to receive a request including trading parameters including, for example, initial parameters and reconfiguration parameters 102. An order having initial parameters is prepared 104. In such an order, the dynamic parameter is equal to the start point. The order is sent to a trading forum for execution of the trade 106. After a selected time interval 108, a determination 110 is made whether the order has been fully executed. If the order has been fully executed, the end step is reached, as illustrated in FIG. 1A. If the order has been partially filled or not filled at all, a request for cancellation of the order is submitted to the forum 112, and a confirmation of the order cancellation is received 114. The system evaluates whether the dynamic parameter in the most recently pending order has reached the end point 116. If the dynamic parameter is equal to the end point, the end step is reached. If the dynamic parameter has not reached the end point, an order having reconfiguration parameters is prepared 105. In embodiments of such an order, a dynamic parameter equals the start point plus the value of the increment times the iteration number. The steps are repeated until the end step is reached.

Embodiments of the trading system may permit sending information regarding the order status to the investor at certain points, as illustrated in FIG. 1B. For example, information may be transmitted to the investor before the end of the method 118A and 118B or before preparing a next iteration reconfigured order in step 118C. The order status may be transmitted to the customer by, for example, sending an email, sending a text message such as an SMS, providing a system notification such as a pop-up screen or a push notification, populating a section of a status chart 80, calling the customer with an automated message, showing a status display, or other information transfer method known in the art.

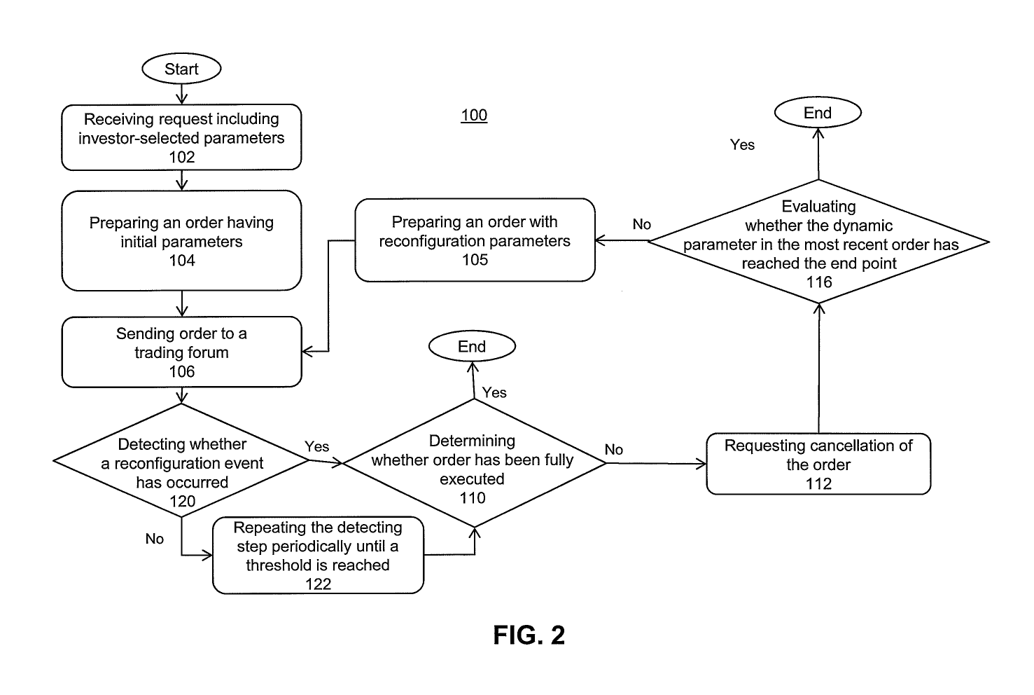

As illustrated in FIG. 2, certain embodiments of the system and method 100 include detecting whether a reconfiguration event has occurred 120 after sending the order to the forum 106. If the reconfiguration event has not occurred, the detecting step is repeated at a time and rate until a threshold number of attempts are conducted 122. Such threshold may be selected as a parameter by the investor or may be pre-selected by the financial institution. If a reconfiguration event is not detected after reaching the threshold, the method comes to an end. If the reconfiguration event has occurred, the system determines whether the order has been fully executed 110.

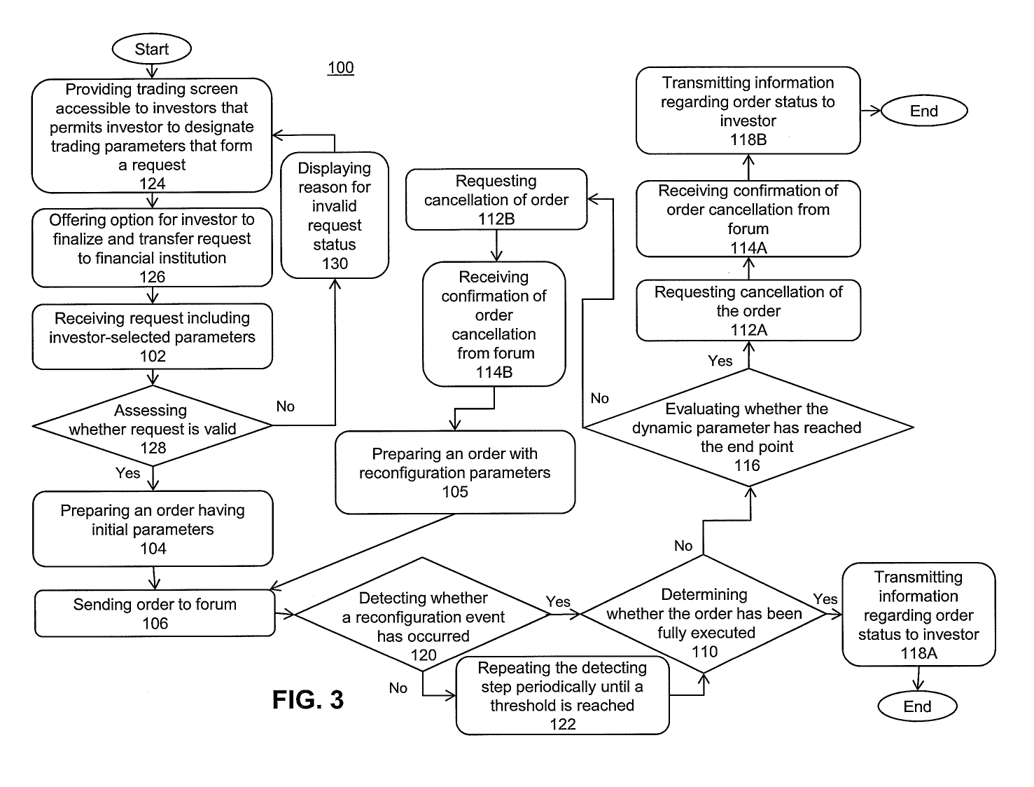

As illustrated in FIG. 3, an embodiment of a method 100 according to the present invention may include providing a trading screen accessible to investors that permits the investor to designate trading parameters that form a request 124. Such embodiments also include offering an option for an investor to finalize and transfer the request to the financial institution 126. After receiving the request including the investor-selected parameters 102, an assessment may be conducted to determine whether the request is valid 128. The assessing step 128 may include, for example, assessing whether the investor has filled in each and every field in the request or assessing whether that which has been entered in the field is an appropriate entry (e.g., number entered in quantity field). If the request is not valid, a reason for the invalid request is displayed 130. If the request is valid, an order having initial parameters is prepared 104, and the method continues with the subsequent steps.

Also illustrated in FIG. 3, certain embodiments of the system and method 100 include conducting the evaluating step 116 before cancellation of the order 112. In such embodiments, if the evaluation reveals that the dynamic parameter has reached the end point, the pending order is cancelled 112A, a confirmation of the cancellation is received 114A, the order status is transmitted to the investor 118B, and the method ends. If the evaluation reveals that the dynamic parameter has not reached the end point, the request is cancelled 112B, a confirmation of the cancellation is received 114B, a next iteration order is prepared 104, and the method continues with the subsequent steps.

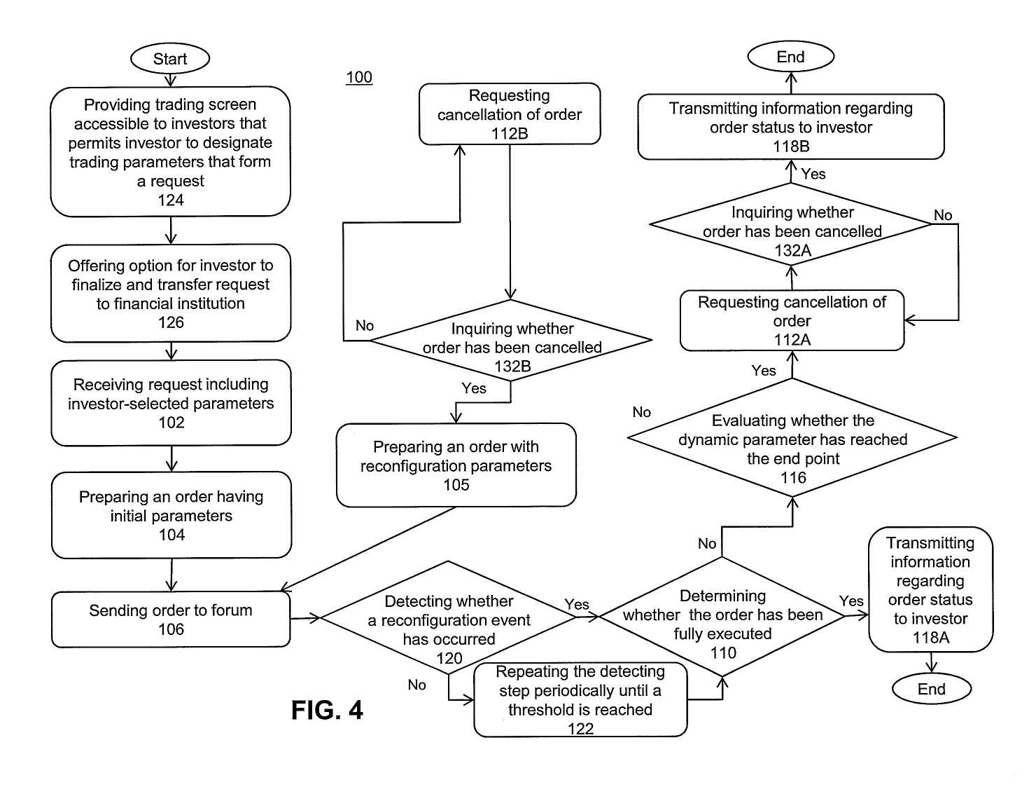

As illustrated in FIG. 4, certain embodiments of the method 100 according to the present invention may include inquiring whether the order has been cancelled 132A, 132B. Such a step may be performed in embodiments in which a confirmation of order cancellation is not received. If the order has not been cancelled, another request for cancellation of the order is sent to the forum 112A, 112B. If the order has been cancelled after inquiry 132A, information regarding the order status is transmitted to the investor 118B and the method ends. If the order has been cancelled after inquiry 132B, a next iteration order is prepared 104, and the method continues with the subsequent steps.

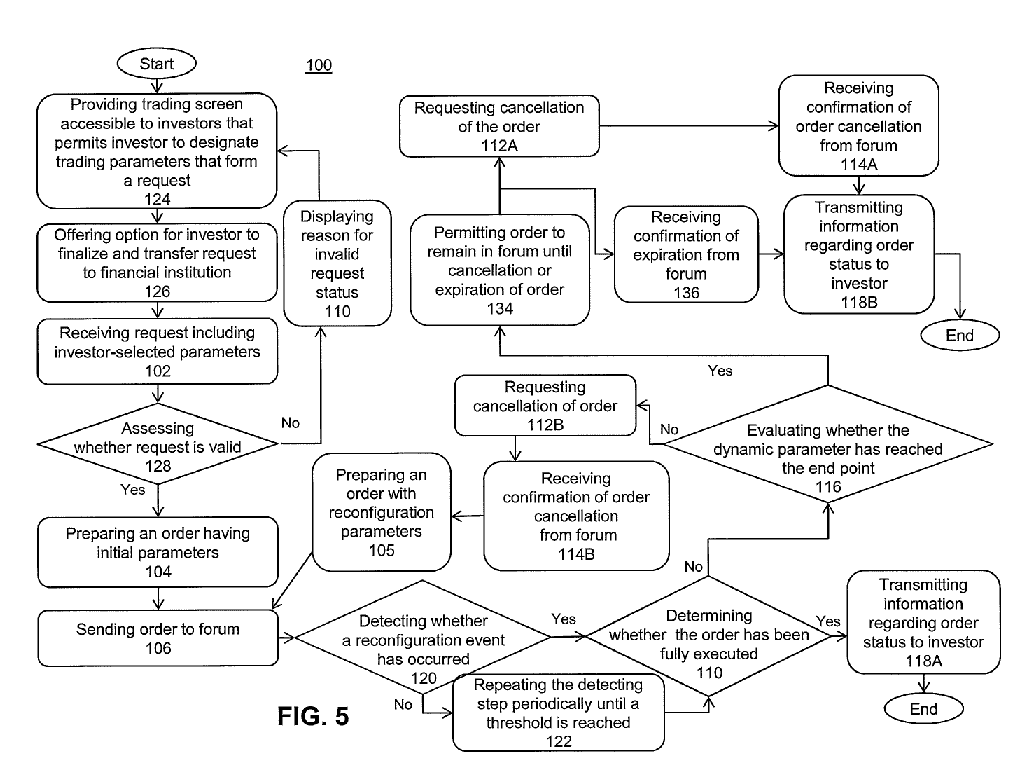

As illustrated in FIG. 5, after an evaluation reveals that an order has a dynamic parameter equal to the end point 116, the order may be permitted to remain in the forum until the first of either expiration of order 136 or cancellation of the order 112A. When an order expires, the forum may send a confirmation of such expiration and the system receives such confirmation.

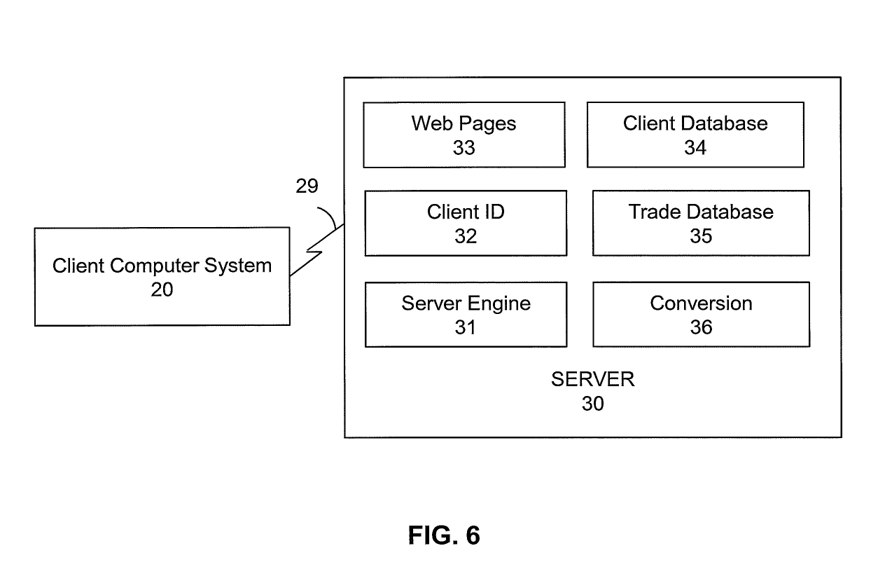

FIG. 6 is a block diagram illustrating an embodiment of the present invention. Certain embodiments include a client computer 20 and a server 30. Embodiments of the server system 30 includes a server engine 31, a client identifier 32, web pages 33, a customer database 34, a trade database 35 and a smart logic algorithm 36. The server engine 31 receives requests to access web pages 33 identified by uniform resource locators (or “URLs”) and provides the Web pages 33 to the various client systems 20. Such a request may indicate that the customer has performed the selection to finalize and submit the trading request. The customer database 34 contains customer information such as the name of the customer and billing information. The trade database 35 contains a description of the various securities or items that may be traded as well as those trades that have been fulfilled or executed. The server 30 implements a conversion algorithm element 36 that registers the selections made by the customer and converts the request selections to an order. The smart logic algorithm then populates the order for sending to the forum for execution.

In certain embodiments, the server 30 assigns and sends the client identifier 32 to the client system 20 upon interaction between the client system 20 and the server system 30. The server system 30 and client system 20 interact by exchanging data via a communications link 29.

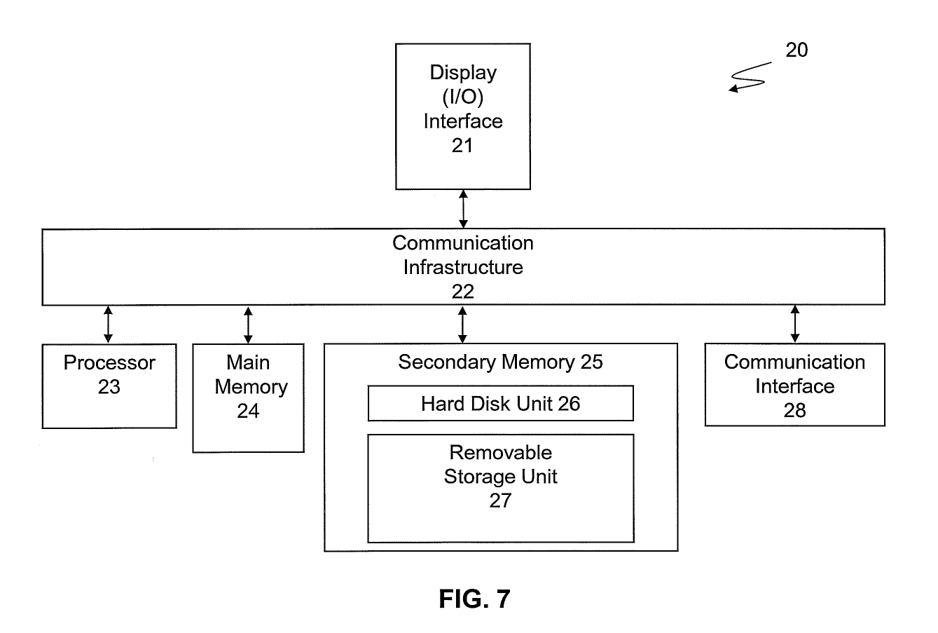

FIG. 7 illustrates an exemplary client computer system 20 that may be used to implement the methods according to the invention. One or more computer systems 20 may carry out the methods presented in this application as computer code.

Computer system 20 includes an input/output display interface 21 connected to communication infrastructure 22—such as a bus—, which forwards data such as graphics, text, and information, from the communication infrastructure 22 or from a frame buffer (not shown) to other components of the computer system 20. The input/output display interface 21 may be, for example, a keyboard, touch screen, joystick, trackball, mouse, monitor, plasma display, rear projector, speaker, printer, any other computer peripheral device, or any combination thereof, capable of entering and/or viewing data. While most common input/output display interfaces 21 are designed to present information dynamically in a visual medium, tactile displays, usually intended for the blind or visually impaired, use mechanical parts to dynamically update a tactile image (usually of text) so that the image may be felt by the fingers.

Embodiments of computer system 20 include one or more processors 23, which may be a special purpose or a general-purpose digital signal processor that processes certain information. Computer system 20 also may include a main memory 24, for example random access memory (“RAM”), read-only memory (“ROM”), mass storage device, or any combination thereof. Computer system 20 may also include a secondary memory 25 such as a hard disk unit 26, a removable storage unit 27, or any combination of secondary memories. Computer system 20 may also include a communication interface 28, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, or anything else that permits the sending and receiving of data such as trading requests and information regarding trading.

It is contemplated that the main memory 24, secondary memory 25, communication interface 28, or a combination, function as a computer usable storage medium, otherwise referred to as a computer readable storage medium, to store and/or access computer software including computer instructions. For example, computer programs or other instructions may be loaded into the computer system 20 such as through a removable storage device, for example, a floppy disk, ZIP disks, magnetic tape, portable flash drive, optical disk such as a CD or DVD or Blu-ray, Micro-Electro-Mechanical Systems (“MEMS”), nanotechnological apparatus. Specifically, computer software including computer instructions may be transferred from the removable storage unit 27 or hard disc unit 26 to the secondary memory 25 or through the communication infrastructure 22 to the main memory 24 of the computer system 20. In certain embodiments, computer readable storage mediums exclude any transitory signals.

Embodiments of a communication interface 28 allows software, instructions and data to be transferred between the computer system 20 and external devices or external networks. Software, instructions, and/or data transferred by the communication interface 28 are typically in the form of signals that may be electronic, electromagnetic, optical, or other signals capable of being sent and received by the communication interface 28. Signals may be sent and received using wire or cable, fiber optics, a phone line, a cellular phone link, a Radio Frequency (“RF”) link, wireless link, or other communication channels.

Computer programs, when executed, enable the computer system 20, particularly the processor 23, to implement the methods of the invention according to computer software including instructions.

The computer system 20 may perform any one of, or any combination of, the steps of any of the methods described in this application. It is also contemplated that the methods according to the invention may be performed automatically, or may be invoked by some form of manual intervention.

The computer system 20 of FIG. 7 is provided only for purposes of illustration, such that the invention is not limited to this specific embodiment. It is appreciated that a person skilled in the relevant art knows how to program and implement the invention using any computer system.

The computer system 20 may be in the form of a desktop computer, laptop computer, tablet computer, netbook computer, or a handheld device including, for example, a personal digital assistant (“PDA”), smart hand-held computing device, cellular telephone, hand held console, or MP3 player, such as an iPad®, iPad Touch® or Phone®.

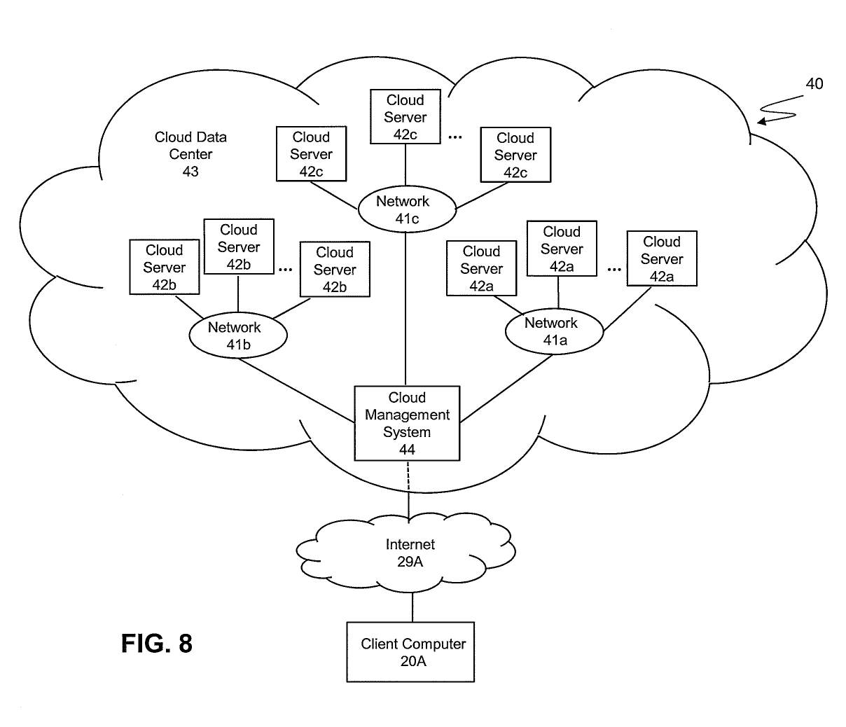

FIG. 8 illustrates an exemplary cloud computing system 40 that may be used to implement certain method steps according to the present invention. The cloud computing system 40 includes a plurality of interconnected computing environments. The cloud computing system 40 utilizes the resources from various networks as a collective virtual computer, where the services and applications can run independently from a particular computer or cloud server configuration making hardware less important.

Specifically, the cloud computing system 40 includes at least one client computer 20. The client computer 20 may be any embodiment of a computer system 20 described above. The client computer 20 establishes communication with the Internet 29A—specifically to one or more cloud servers—to, in turn, establish communication with one or more cloud data centers 43. A cloud data center 43 includes one or more networks 41a, 41b, 41c managed through a cloud management system 44. Each network 41a, 41b, 41c includes cloud resource servers 42a, 42b, 42c, respectively. Cloud servers 42a, 42b, 42c permit access to a collection of computing resources and components that can be invoked to instantiate a virtual machine, process, or other resource for a limited or defined duration. For example, one group of cloud resource servers can host and serve an operating system or components thereof to deliver and instantiate a virtual machine. Another group of cloud resource servers can accept requests to host computing cycles or processor time, to supply a defined level of processing power for a virtual machine. A further group of cloud resource servers can host and serve applications to load on an instantiation of a virtual machine, such as an email client, a browser application, a messaging application, or other applications or software.

The cloud management system 44 may comprise a dedicated or centralized cloud server and/or other software, hardware, and network tools to communicate with one or more networks 41a, 41b, 41c, such as the Internet or other public or private network, with all sets of cloud resource servers 42a, 42b, 42c. The cloud management system 44 may be configured to query and identify the computing resources and components managed by the set of cloud resource servers 42a, 42b, 42c needed and available for use in the cloud data center 43. Specifically, the cloud management system 44 may be configured to identify the hardware resources and components such as type and amount of processing power, type and amount of memory, type and amount of storage, type and amount of network bandwidth and the like, of the set of cloud resource servers 42a, 42b, 42c needed and available for use in the cloud data center 43. Likewise, the cloud management system 44 can be configured to identify the software resources and components, such as type of Operating System (“OS”), application programs, and the like, of the set of cloud resource servers 42a, 42b, 42c needed and available for use in the cloud data center 43.

The present invention is also directed to computer products, otherwise referred to as computer program products, to provide software to the cloud computing system 40. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 40 of FIG. 8 is provided only for purposes of illustration and does not limit the invention to this specific embodiment. It is appreciated that a person skilled in the relevant art knows how to program and implement the invention using any computer system or network architecture.

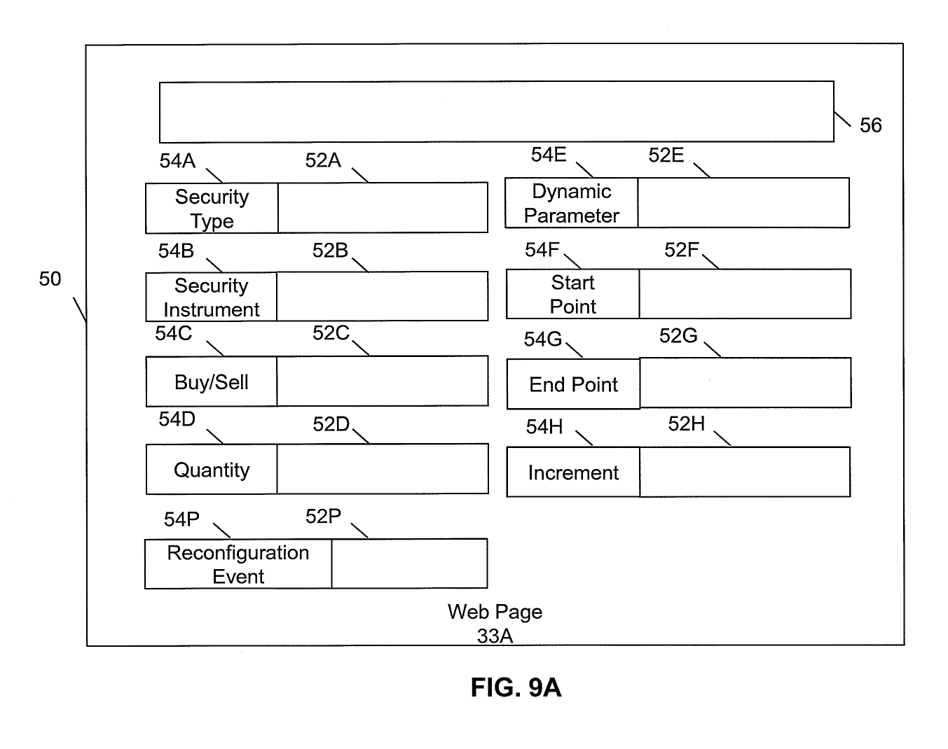

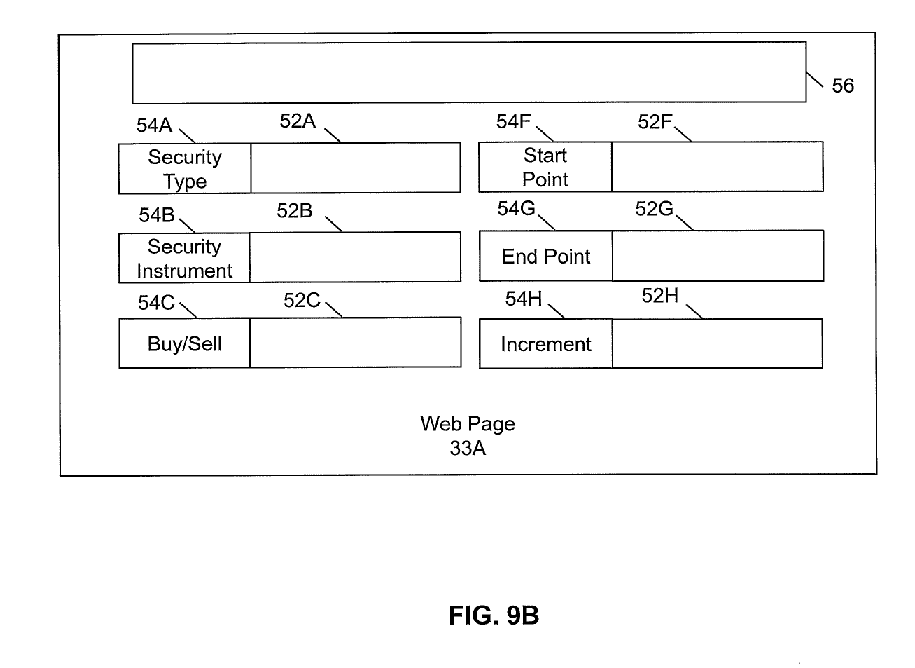

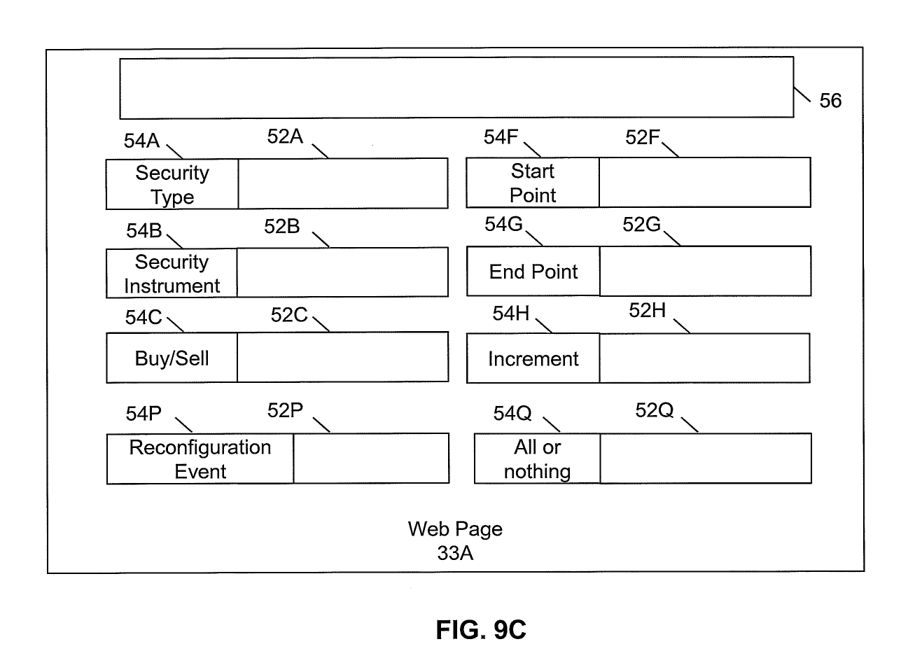

FIG. 9A and FIG. 9B illustrate embodiments of a web page 33A. Certain embodiments of a web page 33A include a number of fields in which the investor may enter a choice, such as by typing in, checking a box, selecting from choices in a menu such as a pull-down/drop-down menu, or other method known in the art, related to that field. As shown in FIG. 9A, certain embodiments of a web page 33A include a security type field 52A, security instrument field 52B, a buy/sell field 52C, a quantity field 52D, a dynamic parameter field 52E, a start point field 52F, an end point field 52G, an increment field 52H, and a reconfiguration event field 52P. Each field 52 may include a respective field label 54. Embodiments of a web page 33A also may include a header 56 in which information about the financial institution or the request is displayed.

In certain embodiments, a buy/sell field 52D permits the investor to enter a choice between buy or sell, while other embodiments permit the investor to enter a choice between “buy to open”, “buy to close”, “sell to open”, or “sell to close”.

The fields and other content on a web page 33 may be configured to permit improved usability. For example, information may be displayed in a simplified manner such that the user is not overwhelmed. Certain information may be split into multiple web pages 33 such that a single web page 33 does not become cluttered.

Certain embodiments of the present invention implement a predetermined formula for the start point or the end point, such that a start point field 52F and an end point field 52G are not necessary or are populated automatically by the system. In certain embodiments, a predetermined formula may include calculating a reference value, or a certain unit amount above or below a reference value to determine a resulting value. A reference value may include a national best bid and offer or “NBBO”, a local best bid and offer, bid price, ask price, market last traded price, investor last traded price, closing price, volume weighted average price, moving average, bid quantity, or ask quantity. A “closing price” is the last price at which a security traded during a regular trading session. In certain embodiments, the reference value is ascertained at the time the initial parameters are set (by, for example, communicating with an external source of such information), and each subsequent order is prepared based on that reference value. In other embodiments, the reference value may be ascertained a number of times, for example, after a certain number of unfulfilled iterations of orders. In certain embodiments, the start point or end point may be determined by the “best of” a group of the resulting values calculated by the system.

In certain embodiments, predetermined formula is used to calculate only the start point. In such embodiments, the investor may select the end point, or the end point may be determined by a second formula, for example, 10 units above or below the start point.

As illustrated in FIG. 9B, certain embodiments might not include a dynamic parameter field 52E. In such embodiments, the dynamic parameter may be selected implicitly by entering information into the start point field 52F and the end point field 52G, or such embodiments only permit one type of dynamic parameter and so a dynamic parameter field is not needed. Also illustrated in FIG. 9B, certain embodiments may not include a quantity field 52D. Certain of such embodiments, the quantity is generally standardized either for that financial institution, that type of security, or that specific investor.

As illustrated in FIG. 9C, certain embodiments include a reconfiguration event field 52P, configured to permit a user to enter information about a reconfiguration event. Embodiments also may include an “all or nothing” field 52Q, configured to permit an inventor to identify whether the trade must be executed in all one trade or if portions of the quantity may be traded in separate transactions. In embodiments in which the all or nothing parameter is selected, each order having initial parameters and reconfigured order, that is, all orders sent to the forum under one request, have the same quantity parameter. Of course, once a new request is sent, a new quantity parameter may be selected.

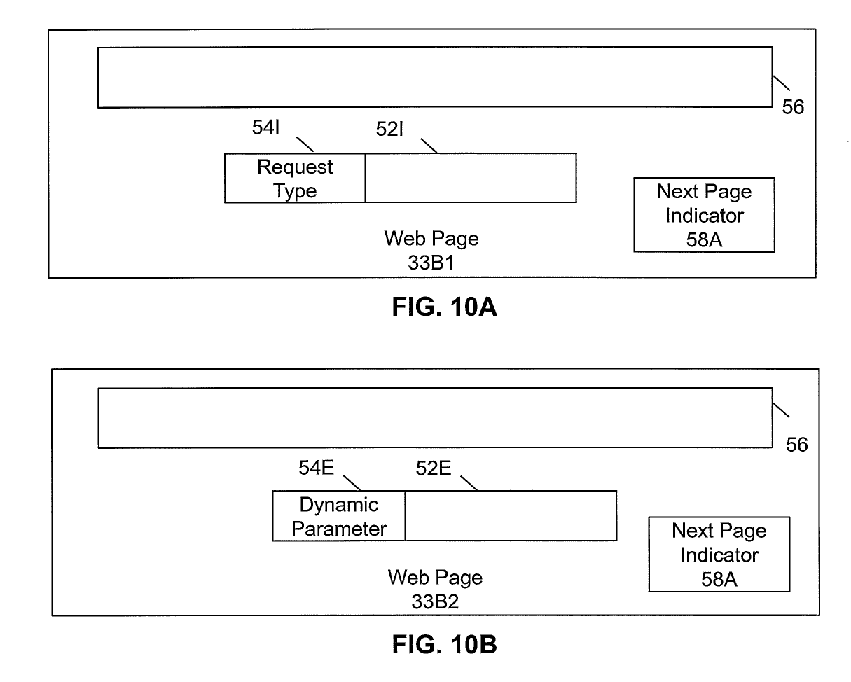

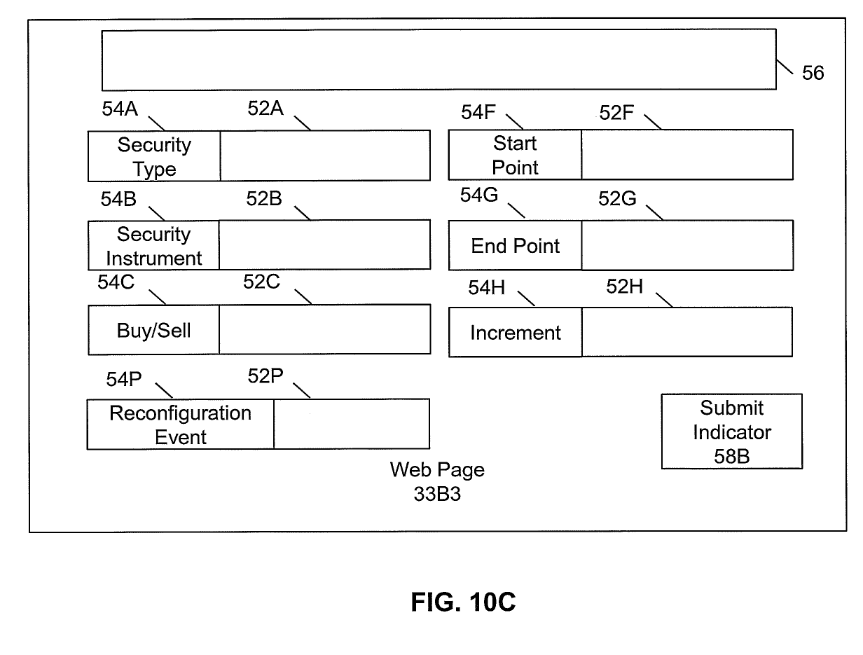

Certain embodiments permit the display of all relevant fields 52 of a request in one webpage 33, examples of such embodiments are illustrated in FIG. 9A, FIG. 9B, and FIG. 9C. Certain other embodiments display one or more of fields 52 on each of more than one web pages 33 or each field 52 may be displayed in its own web page 33. The one or multiple web pages 33 may form the request 50. In such embodiments, each subsequent web page is revealed upon entering the parameter information in the relevant field 52 or upon indicating that the entering process is complete such as by clicking on a navigation tool 58 such as a “next page” navigation indicator 58A or “submit” navigation indicator 58B configured, respectively, to cause the next screen to display or submit the information to the financial institution. Examples of such a series of web pages 33 are illustrated in FIG. 10A—FIG. 10C.

In an embodiment illustrated in FIG. 10A—FIG. 10C, a first web page 33B1 includes a request type field 52I, a request type field label 54I, a “next page” navigation indicator 58A, and a header 56. A second web page 33B2 includes a dynamic parameter field 52E, a dynamic parameter field label 54E, a header 56, and a “next page” navigation indicator 58A. The request type selected in this first web page 33B1 and the dynamic parameter selected in the second web page 33B2 will determine which fields are displayed in FIG. 10C. For example, a request type field 52I may permit selection of a request for preparation of any type of order known in the art such as a market order request, a limit order request, or a series of orders request that include a dynamic parameter. The contents of the subsequent web page 33 displayed is determined based on the request selected. For example, if the market order request is selected, a web page that includes the relevant fields for the preparation of such an order is displayed. If the series of orders request is selected, then the web page 33B2 may be displayed to permit the investor to select the dynamic parameter. In addition, the contents of the subsequent web page 33 displayed is determined based on the dynamic parameter selected. For example, if the investor selects a dynamic parameter of price at which the trade may be executed, the start point field 52F and end point field 52G will refer to the price and no separate price field 52 will be necessary. However, if the investor selects quantity as a dynamic parameter, then the start point field 52F and end point field 52G will refer to the quantity, no quantity field 52D will be displayed, and a price field 52 will be displayed.

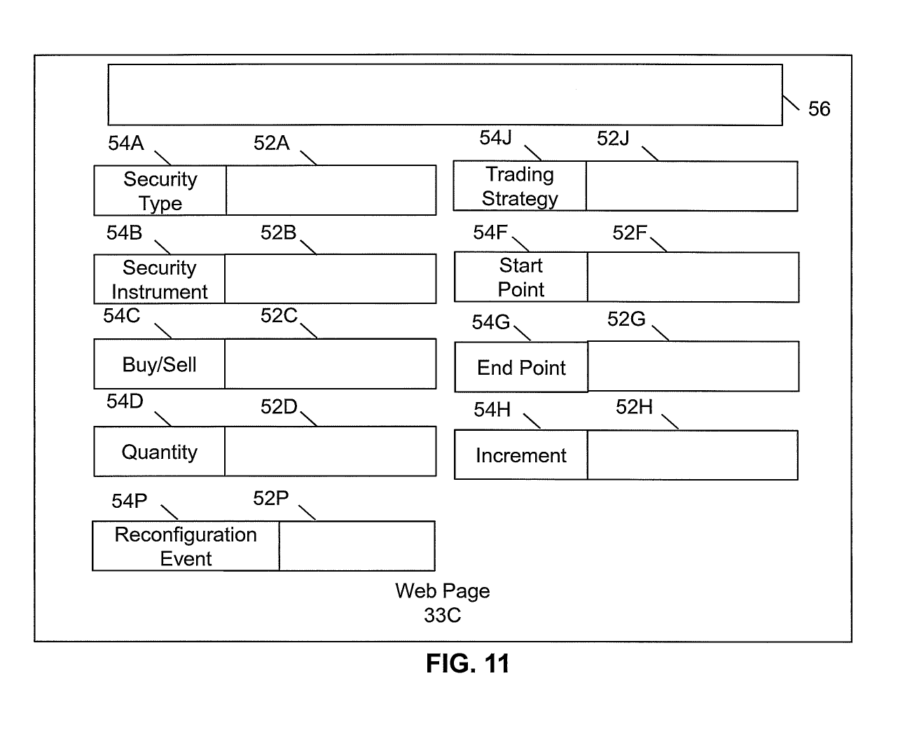

Another embodiment of a web page 33C is illustrated in FIG. 11. Such embodiments include a trading strategy field 52J and a trading strategy field label 54J. An investor may select one of many trading strategies in which more than one series of orders, in which at least one of the series of orders includes a dynamic parameter, may be initiated in a single request. Such strategies often are implemented with respect to options, although they can be used for other securities as well.

Before describing the trading strategies that an investor may select, a few terms are defined. A “call option” or “call” gives a buyer of the contract the right to purchase the underlying asset and gives the seller the obligation to sell a set number of shares of the underlying stock at a specified price—termed the “strike price” on or before the date the contract expires. A “put option” or “put” gives the buyer of the contract the right to sell the underlying asset and give the seller of the contract the obligation to buy a set number of shares of the underlying asset at a specified price—also termed a “strike price” on or before the date contract expires.

Generally, trading strategies may include one or more “spread trades”, which is the simultaneous purchase of one security and sale of a related security, each called legs, as a unit. Embodiments of spread trades may include two-legs, three-legs, or four-legs, etc. In certain embodiments, all legs of a trade are made simultaneously or not at all. In other words, in embodiments having two or more legs, the dynamic parameter for each and every leg must be fulfilled in for the trade to be executed.

Certain trading strategies for options and futures options may include “call spread”, “put spread”, “straddle”, “strangle”, “vertical spread”, “calendar spread”, “diagonal spread”, or other spread trades.

A “call spread” is a spread strategy that involves either buying a call with a lower strike and selling a call with a higher strike, or selling a call with a lower strike and buying a call with a higher strike.

A “put spread” is a spread strategy that involves either selling a put with a higher strike and buying a put with a lower strike, or buying a put with a higher strike price and selling a put with a lower strike price.

A “straddle” is a trading strategy in which a call and a put with the same strike price and expiration are both bought (“long” straddle) or sold (“short” straddle).

A “strangle” is a spread strategy involving buying a put option (“long put”) and a long call or a short put and a short call with different strikes but the same expiration. The most common strangles involve out-of-the-money options. An “out-of-the-money option” is an option that has no intrinsic value because its strike price is above (in the case of a call) or below (in the case of a put) the current market price of the underlying unit, and extrinsic or time value is the only component of an out-of-the-money option's price.

A “vertical spread” is a spread strategy that involves buying at least one option and selling at least one option in which each option has the same expiration, but different strike prices.

A “calendar spread” or “horizontal spread” is a spread strategy that involves buying at least one option and selling at least one option in which each option has the same strike price, but a different expiration than the other.

A “diagonal spread” is a spread strategy that involves buying at least one option and selling at least one option in which each option has a different strike price and a different expiration than each other option.

Certain embodiments in which trade strategies are implemented permit the investor to enter a start point and an end point for a dynamic parameter in each leg of the trade. Accordingly, certain requests 50 include a start point field 52F and an end point field 52G for each leg of a trade. Other embodiments implement a predetermined formula for the start point and the end point, such that a start point field 52F and an end point field 52G are not necessary. As described above, a predetermined formula may include a certain percentage above or below some reference value, which may include a national best bid and offer or “NBBO”, a local best bid and offer, bid price, ask price, last available price, average price over a time period, or closing price of a security. Each leg may have its own predetermined formula or each leg may have the same predetermined formula.

For example, in a two-leg trade in which the dynamic parameter is the price at which investor is willing to execute the trade, one leg may have a starting price at 10% below the ask price and a second leg may have a starting price at 10% above a bid price. In each iteration, the dynamic parameter in each leg may decrease or increase respectively.

In another example, in a two-leg trade in which the dynamic parameter is the price at which investor is willing to execute the trade, one leg may have a starting price 10% below the ask price and a second leg may have a starting price at 6% above a bid price.

Certain embodiments may have a predetermined or investor-designated number of iterations, for example, 3, 4, 5, 6, 7, 8, 9, 10, 11, etc.). Such embodiments will not include an increment field 52H.

The selection of a trading strategy may generate a webpage 33 with a specific set of fields 52. Or, certain embodiments are preconfigured to permit creation of a specific type of request that permits implementation of a two-or-more-leg trade.

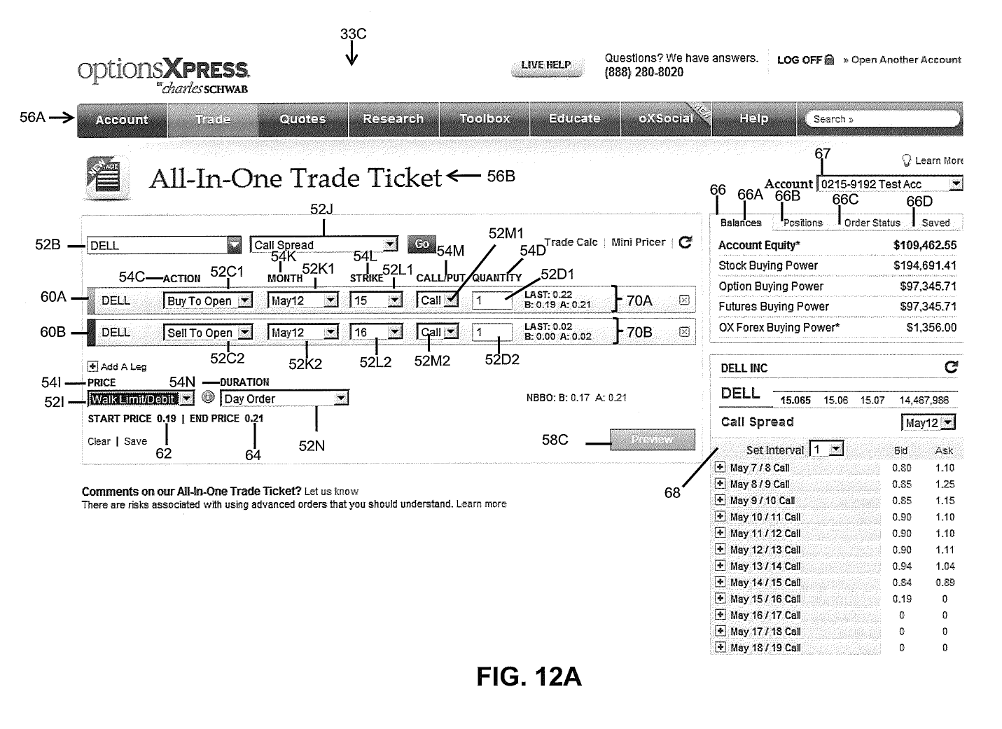

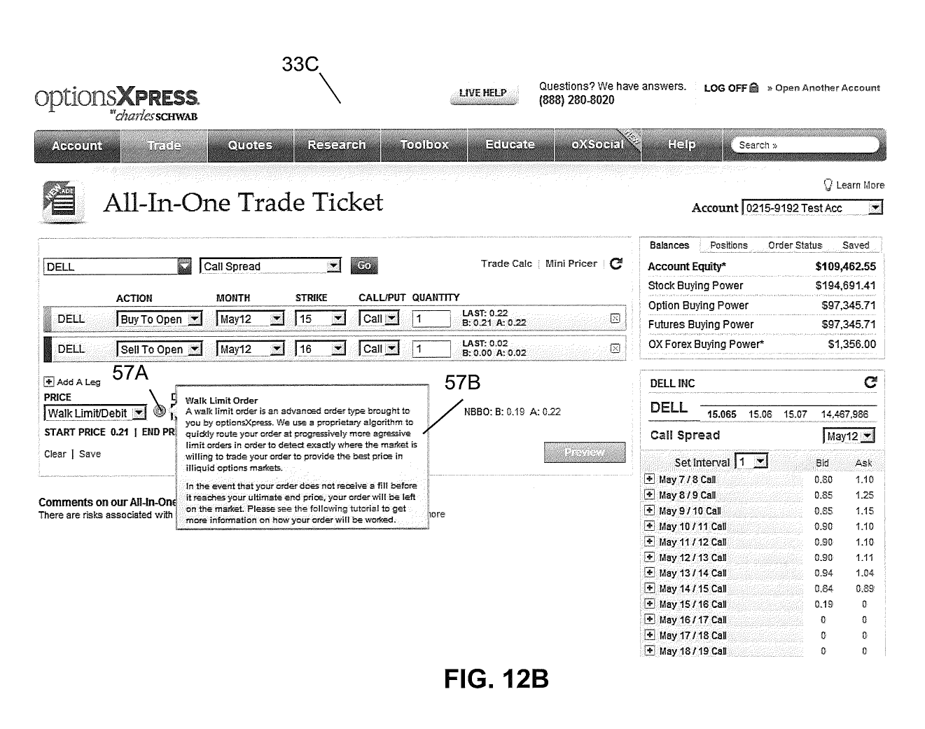

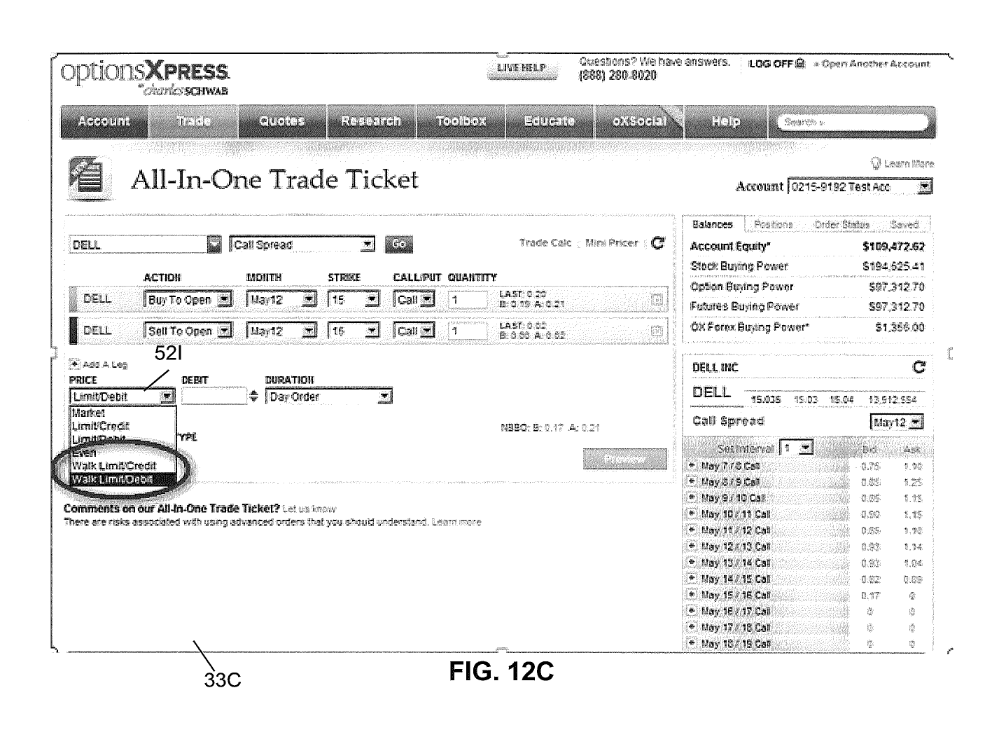

FIG. 12A illustrates another embodiment of a web page 33C configured to permit creation of a request to implement a “call spread” trading strategy in which the start point and end point for each of the two legs are set by the financial institution or are automatically generated based on an algorithm. In the illustrated embodiment, the financial institution automatically implements 10 increments over the time duration selected by the investor in the duration field 52N or the time of sending first order until the end of the duration in the duration field 52N. A duration field 52N may permit the investor to enter options such as “day order” or “good till cancel”, or may permit the investor to enter a certain time such as 10:30 a.m., 3:30 p.m., etc.

Certain embodiment of a web page 33C include a security instrument field 52B and a request type field 52I. The choice of a “call spread” strategy permits the investor to enter certain parameters for each of a first leg 60A and a second leg 60B. Specifically, the web page 33 includes a first buy/sell field 52C1, a second buy/sell field 52C2, a first quantity field 52D1, a second quantity field 52D2, a start point designation 62, an end point designation 64.

The embodiment illustrated in FIG. 12A also includes a number of fields related to the terms of the transaction regarding the underlying asset. Specifically, the web page 33 includes a first “time for transaction” field 52K1, a second “time for transaction” field 52K2, a first strike field 52L1, a second strike field 52L2, a first call/put field 52M1, and a second call/put field 52M2.

The embodiment of FIG. 12A also includes a toolbar header 56A, an informational header 56B, user account information section 66, account number field 67, general market information section 68, and specific market information section 70 for each proposed leg such as a first specific market information section 70A and a second specific market information section 70B. A user account information section 66 may include a balances tab 66A, a positions tab 66B, a status tab 66C, and a saved tab 66D.

FIG. 12B illustrates an embodiment which includes an information icon 57A. Interaction with an information icon 57A, such as rolling a mouse arrow over, clicking on, or selecting, will reveal an information display 57B. The information display 57B illustrated in FIG. 12B includes information about the type of request selected in the request type field 52I. In other embodiments, the information display 57B could be configured to display any type of information including information about a security, trade type, financial institution, trading forum, market conditions, account information, or other information.

FIG. 12C illustrates a pull-down menu in the request type field 52I. In the illustrated embodiments, the options from which the investor may select include “market”, “limit/credit”, “limit/debit”, “even”, “walk limit/credit” and “walk limit/debit”. For purposes of this application, the term “walk limit” refers to an embodiment of a request includes a dynamic parameter.

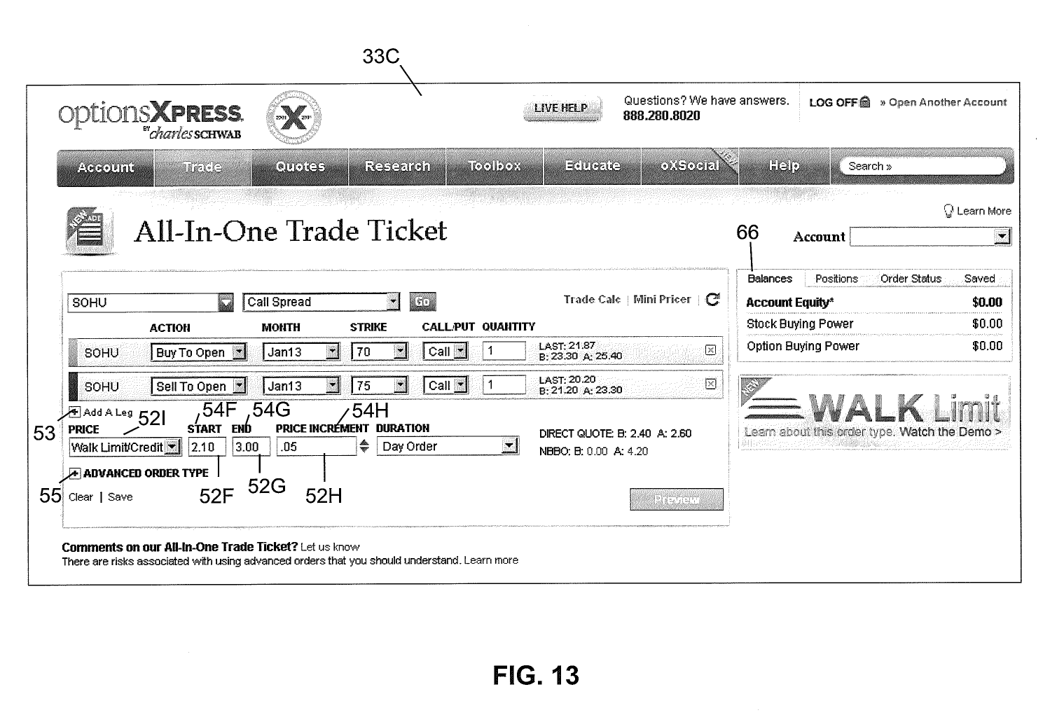

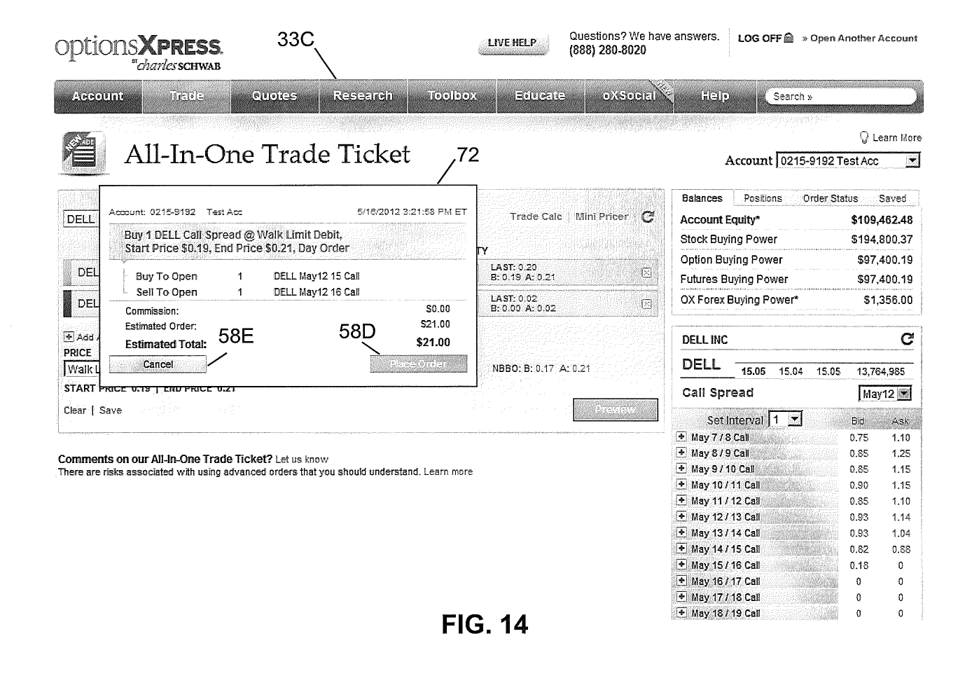

FIG. 13 illustrates an embodiment of the present invention in which a start point field 52F, end point field 52G, and increment field 52H are configured to permit the investor to type in the desired values. FIG. 12B also illustrates an “add a leg” button 53 that can be activated to add another set of fields for an additional leg 60. The “advanced order type” button 55 permits an investor to select additional types of orders.

In embodiments such as those illustrated in FIG. 13, a reconfiguration event may be time, such that a pending order is cancelled and a reconfigured order is sent every pre-determined time interval. In other such embodiments, the time interval is calculated by the system such that the dynamic parameter reaches the end point by the end of the indicated duration. In other words, the system may calculate when the reconfiguration event will occur by finding the time until order expires divided by number of increments to reach the ending point. Specifically, if the request shown in FIG. 13 includes an initial parameters order sent to the forum at 12:00 pm and the day order expired at 4:30 pm, there would be four and a half hours until the last order expired. There are a possibility of eighteen orders (excluding the initial parameters order) in which each order has a dynamic parameter of price between $2.10 and $3.00 at each five cent increment. Accordingly, since four and a half hours divided by eighteen equals 15, each reconfiguration event would be the passage of 15 minutes. If certain other sets of information is available, other calculations may be done to determine when a reconfiguration event will occur. Similarly, the increment value may be calculated by a similar method with different set of given information.

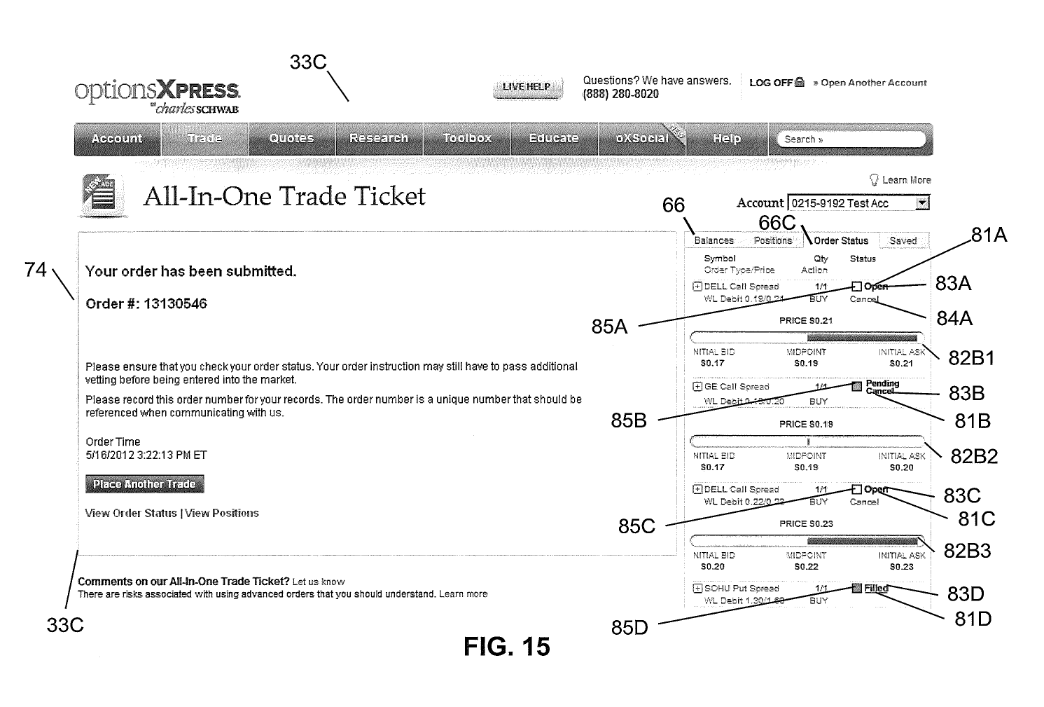

When the investor is prepared to submit the request to the financial institution, the investor may select the “preview” navigation indicator 58C. In certain embodiments, a preview screen 72 is displayed in which certain parameters of the request, account information, and other information may be displayed. The preview screen 72 may include a “place order” navigation indicator 58D or a “cancel” navigation indicator 58E. Activating such as by clicking on or otherwise selecting the “cancel” navigation indicator 58E causes the preview screen 72 to disappear and permits the investor to amend the request if desired. Activating a “place order” navigation indicator 58D causes the request to be transferred to the financial institution. In certain embodiments, transferring the request also causes the display of a confirmation screen 74 that may include a confirmation statement, a reference number, the time the request was submitted, instructions, and other information. An embodiment of a web page 33C including a confirmation screen 74 is illustrated in FIG. 15.

FIG. 15 illustrates an embodiment of a confirmation screen 74 that also includes a user account information section 66 including a status tab 66C. As illustrated in FIG. 15, the status tab 66C may show one or more status displays 82B. A status display 82B may include a status bar, a status classification, a status graph, or any other visual element configured to convey information about the status of a pending order. Each status display 82B may include information about one or more requests or orders. A first status bar display 82B1 illustrates the status of a pending order from a first request. A second status bar display 82B2 illustrates the status of a pending order from a second request. A third status bar display 82B3 illustrates the status of a pending order from a third request of the user.

FIG. 15 also illustrates a status classification 81, which may include a description of the request/order status 83 and a coded classifier of the request/order status 85. A description of the request/order status 83 may include any text configured to convey information about the request/order status, for example, the text “open” 83A, 83C; “pending cancel” 83B; or “filled “83D”. A coded classifier of the request/order status 85 may include any symbol configured to convey information about the request/order status, for example, the color white for an “open” status 85A, 85C, the color orange for a “pending cancel” status 85B, or a color green for a “filled” status 85D. Certain embodiments of status classification 81 also may include a cancel request action button 84A, which permits the user, for example, to cancel a pending order or request.

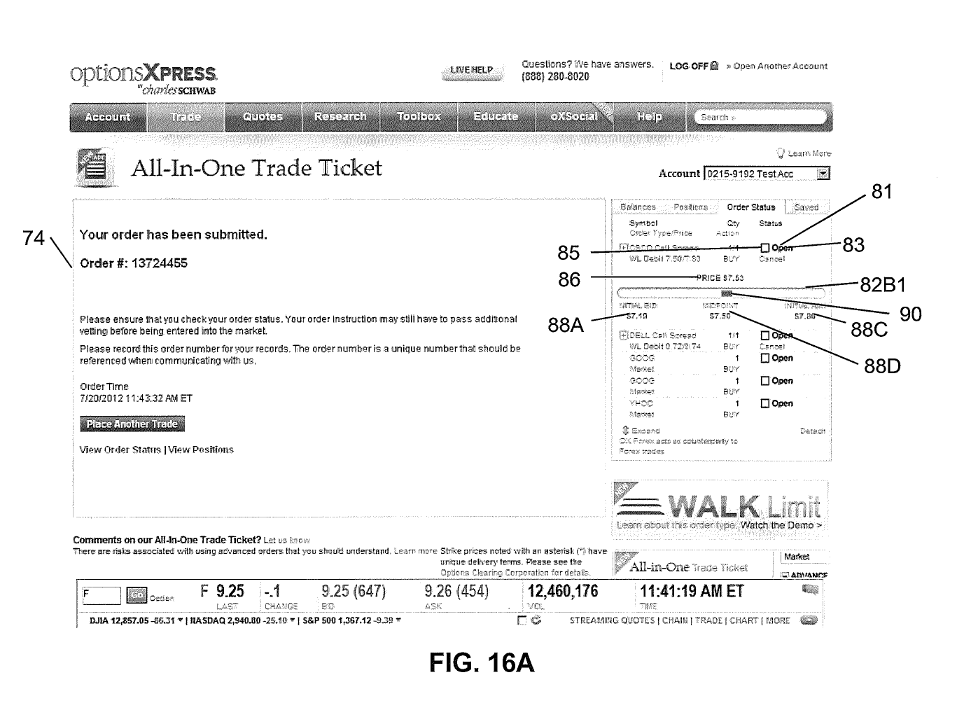

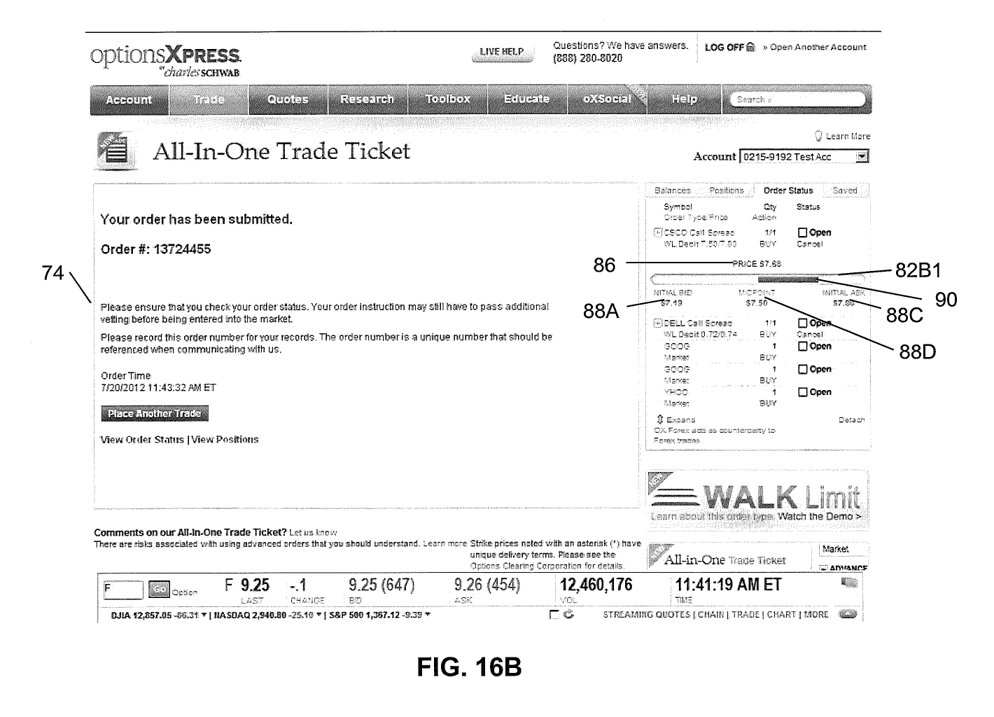

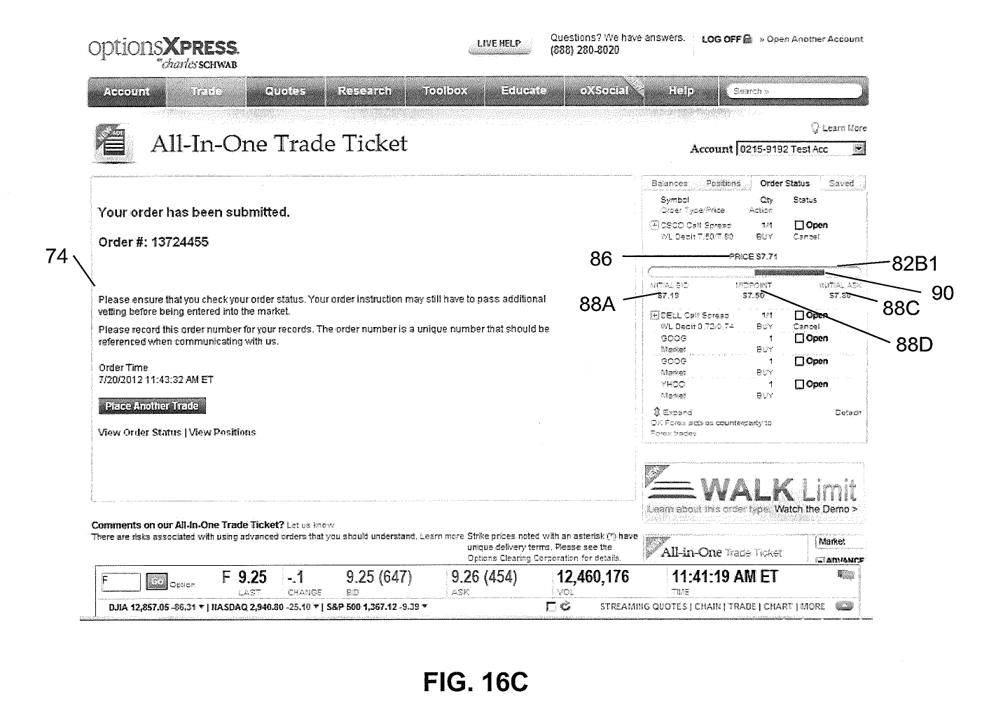

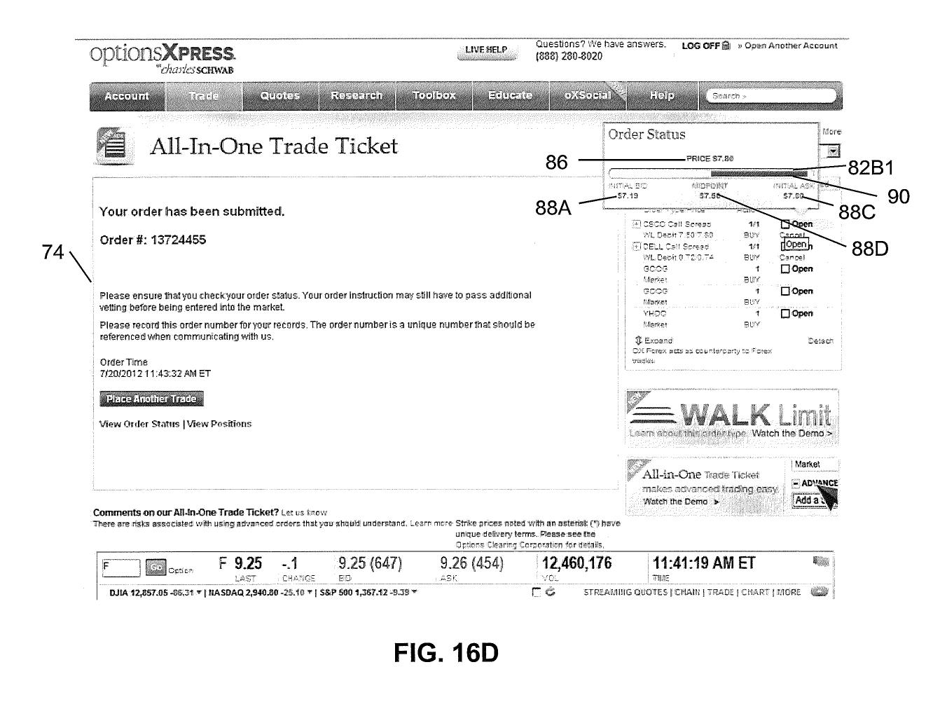

Embodiments of a status bar display 82B1 may include a price description 86, one or more bar display labels 88, and a progression bar 90. A price description 86 may describe the price in a currently pending order. A first bar display label 88A may identify an initial bid price, a second bar display label 88B may identify a midpoint, and a third bar display label 88C may identify an initial ask price. A progression bar 90 may provide information about the dynamic parameter in the pending order relative to the other iterations of such parameter. In FIG. 16A, the progression bar 90 is close to the midpoint. After one or more iterations of orders have been sent and cancelled, the progression bar 90 is updated accordingly and is sized and shaped to display an order having a different dynamic parameter in FIG. 16B and FIG. 16C. In FIG. 16D, the progression bar 90 illustrates that the dynamic parameter is near an end point.

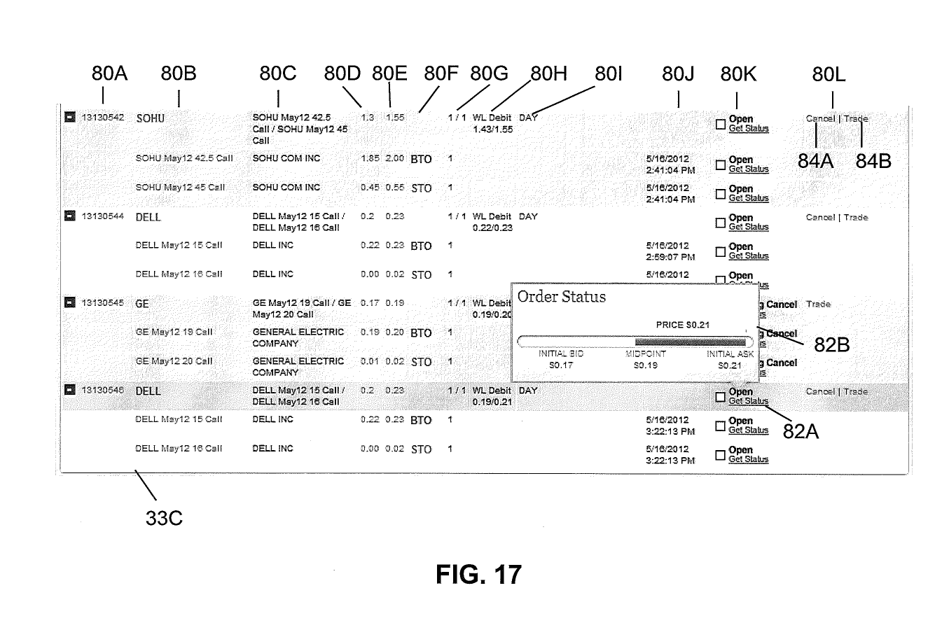

FIG. 17 illustrates an embodiment of a status screen on a web page 33C. Certain embodiments of the status screen, including the illustrated embodiment, include a status chart 80 generated by the system. Embodiments of a status chart 80 may include one or more columns including a request reference number column 80A, a request title/request leg title column 80B, request details column 80C, bid price column 80D, ask price column 80E, buy/sell column 80F, quantity column 80G, request type field 80H, duration column 80I, time of request execution column 80J (or a time of last iteration column), detailed status icon column 80K, and an action column 80L.

An order status icon column 80K may include detailed status icons 82A. Interaction with an order status icon 82A will cause the reveal of an order status display 82B. The order status display 82B illustrated in FIG. 17 includes information such as the dynamic parameter value of the order most recently sent the forum, the relative progression of the iterations included in the request, or other information. The status chart also may permit tracking information about pending orders such as a countdown until an order expires, countdown until a reconfiguration event occurs, status such as price and quantity of partially executed orders, and other information. Certain embodiments of a status column 80K may be configured to display any type of information including information about a security, trade type, financial institution, trading forum, market conditions, account information, or other information.

An action column 80L may include action buttons 84 such as a cancel request action button 84A and a trade action button 84B. Activation of the cancel request action button 84A permits the investor to cancel the request, for example, at any time before the request expires or after a certain number of iterations have been sent to the forum.

While the disclosure is susceptible to various modifications and alternative forms, specific exemplary embodiments of the present invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A system for facilitating trading in one or more items by a customer, comprising:
a processor;
a main memory in communication with the processor via a communication infrastructure and storing instructions that, when executed by the processor, cause the processor to:
provide a computer trading screen displayed on a display interface, said computer trading screen having a plurality of parameter fields that permit entry of information including initial parameters and reconfiguration parameters, wherein information entered into the plurality of parameter fields forms a request;
prepare an order having initial parameters and reconfiguration parameters, the initial parameters including a dynamic parameter at a start point and the reconfiguration parameters including a threshold number of reconfigured orders;
send the order to a trading forum;
wait a time interval;
determine whether the order has been executed by the trading forum;
if the order has been fully executed, reach an end step;
if the order has not been fully executed, request cancellation of the order;
evaluate whether the dynamic parameter in the order has reached an end point;
if the dynamic parameter has reached the end point, reach the end step;
if the dynamic parameter in the order has not reached the end point, then prepare a reconfigured order with the dynamic parameter changed by an increment relative to the order pending previously;
restart the method at said send step such that the reconfigured order is sent to the trading forum and practice the subsequent steps until the end step is reached or the threshold number of reconfigured orders is met.

2. The system of claim 1 in which the dynamic parameter is a price parameter that designates a price at which the customer wishes to execute a trade of the item.

3. The system of claim 1 in which the dynamic parameter is a price range parameter that designates a price range within which the customer wishes to execute a trade of the item.

4. The system of claim 1 in which the increment is static such that, in every iteration of the reconfigured order, the dynamic parameter changes by the same increment.

5. The system of claim 1 in which the increment is unidirectional such that, in every iteration of the reconfigured order, the dynamic parameter changes in one direction chosen from an upward direction or a downward direction.

6. The system of claim 1 in which the start point is calculated relative to a reference value.

7. The system of claim 1 in which the end point is calculated relative to a reference value.

8. The system of claim 1 in which the order having initial parameters and each of the reconfigured orders include an active “all or nothing” parameter such that the entire quantity in the order is traded or no portion of the quantity is traded at all, and accordingly, each order has the same quantity parameter relative to all other orders caused to be sent to the forum from a single request.

9. The system of claim 1 in which the main memory in communication with the processor stores instructions that, when executed by the processor, cause the processor also to after the determine step and before reaching the end step, transmit information regarding order status to the customer.

10. The system of claim 1 in which the main memory in communication with the processor stores instructions that, when executed by the processor, cause the processor also to if the dynamic parameter has reached the end point in the evaluate step, permit the order to remain in forum until cancellation or expiration of order before reaching the end step.

11. The system of claim 1, wherein the computer trading screen includes a trading strategy field that permits selecting a trading strategy, wherein the selecting a trade strategy step permits entry of information related to at least a first leg of a trade and a second leg of a trade.

12. The system of claim 1, wherein the main memory in communication with the processor stores instructions that, when executed by the processor, cause the processor also to calculate a start point using a predetermined formula and populate automatically the start point as calculated in a start point field in the computer trading screen.

13. The system of claim 1, wherein the main memory in communication with the processor stores instructions that, when executed by the processor, cause the processor also to calculate the end point using a predetermined formula and populate automatically the end point as calculated in an end point field in the computer trading screen.

14. The system of claim 1 wherein the main memory in communication with the processor stores instructions that, when executed by the processor, cause the processor also to: generate and display a status screen page configured to permit the customer to review, track, or cancel at least one or more orders resulting from the request.

15. The method of claim 14, wherein the generate and display step includes showing a status bar display having a progression bar.

16. A system for facilitating trading in one or more items by a customer, comprising:
a processor;
a main memory in communication with the processor via a communication infrastructure and storing instructions that, when executed by the processor, cause the processor to:
provide a simplified computer trading screen displayed on a display interface, said computer trading screen having a plurality of parameter fields that permit entry of information including initial parameters and reconfiguration parameters, wherein information entered into the plurality of parameter fields forms a request;
prepare an order having initial parameters including a dynamic parameter at a start point;
send the order to a trading forum;
detect whether a reconfiguration event has occurred;
if the reconfiguration event has not occurred, the detect step is repeated at a time and rate until a threshold number of attempts are conducted;
upon occurrence of the reconfiguration event or reaching the threshold number of attempts to detect occurrence, determine whether the order has been executed by the trading forum;
if the order has been fully executed, reach an end step;
if the order has not been fully executed, request cancellation of the order; and
evaluate whether the dynamic parameter in the order has reached an end point;
if the dynamic parameter has reached the end point, reach the end step;
if the dynamic parameter in the order has not reached the end point, then prepare a reconfigured order having reconfiguration parameters in which the dynamic parameter changes by an increment relative to the order pending previously;
restart the method at said sending step such that the reconfigured order is sent to the trading forum and practicing the subsequent steps until the end step is reached.

17. A system configured to permit a customer to submit a request to a receiving institution and permit a receiving institution to implement the request, comprising:
a processor;
a user interface including web pages that have information fields in which a customer may enter information;
a memory coupled to the processor and storing instructions that, when executed by the processor, cause the processor to execute the steps of:
providing a computer trading screen having a plurality of parameter fields that permit entry of information including initial parameters and reconfiguration parameters, wherein information entered into the plurality of parameter fields forms a request;
preparing an order having initial parameters and reconfiguration parameters, the initial parameters including a dynamic parameter at a start point and the reconfiguration parameters including a threshold number of reconfigured orders;
sending the order to a trading forum;
waiting a time interval;
determining whether the order has been executed by the trading forum;
if the order has been fully executed, reaching an end step;
if the order has not been fully executed, requesting cancellation of the order; and
evaluating whether the dynamic parameter in the order has reached an end point;
if the dynamic parameter has reached the end point, reaching the end step;
if the dynamic parameter in the order has not reached the end point, then preparing a reconfigured order with the dynamic parameter changed by an increment relative to the order pending previously;
restarting the method at said sending step such that the reconfigured order is sent to the trading forum and practicing the subsequent steps until the end step is reached or the threshold number of reconfigured orders is met.

18. The system of claim 17 in which the dynamic parameter is a price parameter that designates a price at which the customer wishes to execute a trade of the item.

19. The system of claim 17 in which the increment is static such that, in every iteration of the reconfigured order, the dynamic parameter changes by the same increment.

20. The system of claim 17 in which the increment is unidirectional such that, in every iteration of the reconfigured order, the dynamic parameter changes in one direction chosen from an upward direction or a downward direction.
